(19) United States
(12) Patent Application Publication
(10) Pub. No.: US 2024/0162739 A1
(43) Pub. Date: May 16, 2024

(54) POWER STORAGE SYSTEM, ELECTRIC EQUIPMENT, AND CONTROL DEVICE

(71) Applicant: NExT-e Solutions Inc., Tokyo (JP)

(72) Inventors: Fumiaki NAKAO, Shizuoka (JP); Kazuo TAKEHARA, Saitama (JP)

(21) Appl. No.: 18/423,341

(22) Filed: Jan. 26, 2024

Related U.S. Application Data
(63) Continuation of application No. PCT/JP2022/028274, filed on Jul. 20, 2022.

(30) Foreign Application Priority Data
Jul. 27, 2021 (JP) 2021-122374

(51) Int. Cl. H02J 7/34; H02J 7/00

(52) U.S. Cl. CPC H02J 7/342; H02J 7/0014; H02J 7/00304; H02J 7/0047; H02J 7/0063; H02J 7/00712; H02J 2207/20

(57) ABSTRACT

Electric equipment includes: a power transmission/reception unit which transmits/receives electric power between a first assembled battery and a second assembled battery; a first power line which is connected to a positive electrode terminal of the first assembled battery and connected to a positive electrode terminal of the second assembled battery via the power transmission/reception unit; a second power line which is connected to a negative electrode terminal of the first assembled battery and connected to a negative electrode terminal of the second assembled battery via the power transmission/reception unit; and a limitation unit which is arranged between the positive electrode terminal of the first assembled battery and the first power line or between the negative electrode terminal of the first assembled battery and the second power line, and limits transmission/reception of electric power via the power transmission/reception unit between the first assembled battery and the second assembled battery.

The contents of the following patent application(s) are incorporated herein by reference:
NO. 2021-122374 filed in JP on Jul. 27, 2021, and
NO. PCT/JP2022/028274 filed in WO on Jul. 20, 2022.

### BACKGROUND

### 1. Technical Field

The present invention relates to a power storage system, electric equipment, and a control device.

### 2. Related Art

Patent Documents 1 to 3 and Non-Patent Document 1 disclose a battery module including an assembled battery which includes a plurality of power storage cells and an equalizing circuit which equalizes a voltage between the plurality of power storage cells of the assembled battery. Patent Document 4 discloses a battery pack including a plurality of battery modules connected in series. Patent Document 5 discloses a battery protection circuit. CITATION LIST

### PATENT DOCUMENT

Patent document 1: Japanese Patent Application Publication No. H11-176483
Patent document 2: Japanese Patent Application Publication No. 2011-087377
Patent document 3: Japanese Patent Application Publication No. 2013-243806
Patent document 4: Japanese Patent Application Publication No. 2019-30180
Patent document 5: Japanese Patent Application Publication No. 2009-183141

### Non Patent Document

Non-Patent Document 1: Linear Technology Corporation, “LTC3300-1—High Efficiency Bidirectional Multicell Battery Balancer”, [Online], [Retrieved on Jul. 13, 2017], Internet, <URL: http://www.linear.com/product/LTC3300-1>

### BRIEF DESCRIPTION OF THE DRAWINGS

FIG. 1 schematically shows an example of a system configuration of a battery pack 100.

FIG. 2 schematically shows an example of an internal configuration of a battery module 112.

FIG. 3 schematically shows an example of an internal configuration of a battery module 114.

FIG. 4 schematically shows an example of an internal configuration of a balance correction unit 220.

FIG. 5 schematically shows an example of an internal configuration of a balance correction circuit 432.

FIG. 6 schematically shows an example of an internal configuration of a DC-DC converter 330.

FIG. 7 schematically shows an example of an internal configuration of a system control unit 130.

FIG. 8 schematically shows an example of a control operation by the system control unit 130.

FIG. 9 schematically shows another example of the internal configuration of the battery module 112.

FIG. 10 schematically shows another example of the internal configuration of the battery module 112.

FIG. 11 schematically shows another example of the internal configuration of the DC-DC converter 330.

FIG. 12 schematically shows an example of a circuit configuration of an overcurrent protection circuit 1232.

FIG. 13 schematically shows an example of a voltage-current characteristic of the overcurrent protection circuit 1232.

FIG. 14 schematically shows an example of a circuit configuration of an overcurrent protection circuit 1432.

FIG. 15 schematically shows an example of a voltage-current characteristic of the overcurrent protection circuit 1432.

FIG. 16 schematically shows an example of a circuit configuration of an overcurrent protection circuit 1632.

FIG. 17 schematically shows an example of a voltage-current characteristic of the overcurrent protection circuit 1632.

FIG. 18 schematically shows an example of a circuit configuration of an overcurrent protection circuit 1832.

FIG. 19 schematically shows an example of a voltage-current characteristic of the overcurrent protection circuit 1832.

FIG. 20 schematically shows an example of an internal configuration of a current control circuit 2030.

FIG. 21 schematically shows an example of a voltage-current characteristic of the current control circuit 2030.

FIG. 22 schematically shows an example of a system configuration of an electric vehicle 2200.

### DESCRIPTION OF EXEMPLARY EMBODIMENTS

Hereinafter, the invention will be described through embodiments of the invention, but the following embodiments do not limit the invention according to claims. All the combinations of the features described in the embodiments are not necessarily essential to means provided by aspects of the invention. Also, the embodiments will be described with reference to the drawings, and the same or like parts illustrated in the drawings may be marked with the same reference numerals to omit overlapping descriptions.

(Outline of Battery Pack 100)

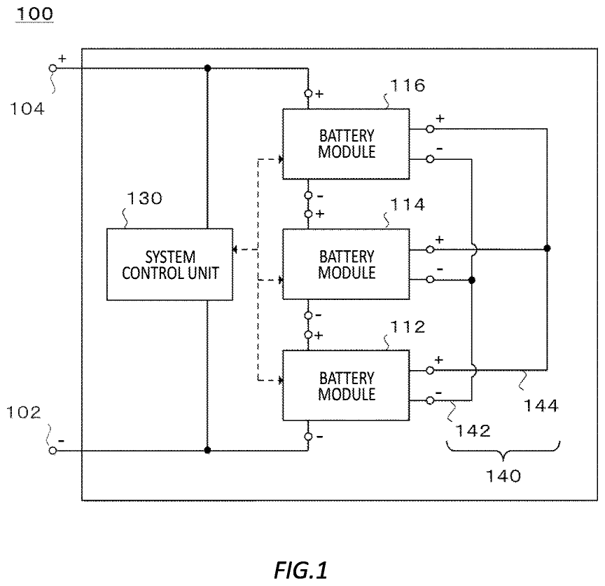

FIG. 1 schematically shows an example of a system configuration of a battery pack 100. In this embodiment, the battery pack 100 supplies electric power to external equipment (which may be referred to as a load) which uses electric power. The above-described operation may be referred to as discharging of the battery pack 100. In this embodiment, the battery pack 100 accumulates electric power supplied from external equipment. The above-described operation may be referred to as charging of the battery pack 100. For example, the battery pack 100 accumulates regenerative electric power from the load. The battery pack 100 may accumulate electric power supplied from a charging device.

In this embodiment, the battery pack 100 includes a terminal 102, a terminal 104, a battery module 112, a battery module 114, a battery module 116, a system control unit 130, and a power transmission bus 140. In this embodiment, the power transmission bus 140 includes a low potential bus 142 and a high potential bus 144.

In this embodiment, the terminal 102, the terminal 104, the battery module 112, the battery module 114, and the battery module 116 are connected in series. In addition, in this embodiment, at least two of the battery module 112, the battery module 114, or the battery module 116 transmit/receive electric power to/from each other via the power transmission bus 140. In this manner, the voltages or states of charge (SOC) of the battery module 112, the battery module 114, and the battery module 116 can be equalized. The SOC is an index representing a charge/discharge state, and is defined as, for example, 100% for a fully charged state and 0% for a fully discharged state.

However, in a case where an abnormality occurs in the function or operation of transmitting/receiving electric power via the power transmission bus 140, when the above-described abnormality is left untreated for a long period of time, the variation in voltage or SOC between the battery modules may increase. In many cases, the battery module is provided with a protection circuit for protecting the battery module from being damaged due to overdischarge or overcharge. However, when the above-described abnormality is further left untreated for a longer period of time, deterioration of the battery module can be promoted due to overcharge or overdischarge.

According to this embodiment, when an abnormality occurs in the function or operation of transmitting/receiving electric power via the power transmission bus 140, the amount of electric power transmitted/received via the power transmission bus 140 is limited. Specifically, the function or operation of transmitting/receiving electric power via the power transmission bus 140 is stopped, or the amount of electric power transmitted/received via the power transmission bus 140 decreases. In this manner, an increase in variation in voltage or SOC between the battery modules is suppressed. In addition, the damage or deterioration of the battery module is suppressed.

As described above, in this embodiment, the terminal 102, the terminal 104, the battery module 112, the battery module 114, and the battery module 116 are connected in series. Therefore, even when the amount of electric power transmitted/received via the power transmission bus 140 is limited, the battery pack 100 can transmit/receive electric power to/from external equipment.

(Outline of Each Unit of Battery Pack 100)

In this embodiment, the terminal 102 and the terminal 104 electrically connect external equipment and the battery pack 100. In this embodiment, the terminal 102 is a negative electrode terminal of the battery pack 100, and the terminal 104 is a positive electrode terminal of the battery pack 100.

Here, the phrase “electrically connected” does not necessarily mean that a first element and a second element are directly connected. A conductive third element may be interposed between the first element and the second element. In addition, the phrase “electrically connected” does not necessarily mean that the first element and the second element are physically connected. For example, input winding and output winding in a transformer are not physically connected but are electrically connected.

Further, the phrase “electrically connected” does not necessarily mean that the first element and the second element are actually electrically connected. For example, in a case where the first element and the second element are arranged on two respective members configured to be detachable, the phrase “electrically connected” may be used for a case where the first element and the second element are electrically connected when the two members are connected.

Note that the phrase “connected in series” means that a first element and a second element are electrically connected in series. Also, unless specifically stated otherwise, the “voltage difference” between power storage cells refers to a value obtained by, when the voltages (which may be referred to as inter-terminal voltages) of two power storage cells are compared, subtracting the voltage of the power storage cell having a lower voltage from the voltage of the power storage cell having a higher voltage.

In this embodiment, at least one of the battery module 112, the battery module 114, or the battery module 116 includes a plurality of power storage cells connected in series. Each of the battery module 112, the battery module 114 and the battery module 116 may include a plurality of power storage cells connected in series. At least one of the battery module 112, the battery module 114, or the battery module 116 may further include one or more power storage cells connected in parallel to a plurality of power storage cells connected in series included in each module.

In this embodiment, at least one of the battery module 112, the battery module 114, or the battery module 116 may include equipment or an element which manages charging and discharging of a plurality of power storage cells included in each module. Each of the battery module 112, the battery module 114 and the battery module 116 may include equipment or an element which manages charging and discharging of a plurality of power storage cells included in each module. Each of the battery module 112, the battery module 114 and the battery module 116 may include (i) a plurality of power storage cells connected in series and (ii) equipment or an element which manages charging and discharging of the plurality of power storage cells. (i) The plurality of power storage cells connected in series and (ii) the equipment or element which manages charging and discharging of the plurality of power storage cells may be arranged in physically the same housing.

In this embodiment, the plurality of power storage cells included in the battery module 112, the plurality of power storage cells included in the battery module 114, and the plurality of power storage cells included in the battery module 116 are connected in series. In this embodiment, the plurality of power storage cells included in the battery module 112, the plurality of power storage cells included in the battery module 114, and the plurality of power storage cells included in the battery module 116 are connected in series such that the battery module 112 is at a lower potential and the battery module 116 is at a higher potential.

In this embodiment, the system control unit 130 controls the battery pack 100. For example, the system control unit 130 controls a voltage or SOC equalization operation between a plurality of battery modules. The system control unit 130 may control the voltage or SOC equalization operation between the plurality of power storage cells.

The system control unit 130 may manage the state of the battery pack 100. For example, the system control unit 130 manages at least one of the voltages or the SOCs of the battery module 112, the battery module 114, and the battery module 116. The system control unit 130 may manage the variation in at least one of voltage or SOC between the battery module 112, the battery module 114, and the battery module 116.

The system control unit 130 may control the battery pack 100 such that the variation in at least one of voltage or SOC between the battery module 112, the battery module 114, and the battery module 116 satisfies a predetermined condition. Examples of the predetermined condition can include a condition that the above-described variation is smaller than a predetermined threshold, a condition that the above-described variation is within a predetermined range, and the like. The system control unit 130 may manage the above-described variation by controlling an operation of transmitting/receiving electric power via the power transmission bus 140 (which may be referred to as an inter-battery module equalization operation).

The system control unit 130 may detect an abnormality in the battery pack 100. For example, the system control unit 130 detects an abnormality regarding the inter-battery module equalization operation. When the abnormality regarding the inter-battery module equalization operation is detected, for example, the system control unit 130 limits transmission/reception of electric power via the power transmission bus 140 between the plurality of battery modules. In this manner, an increase in variation in voltage or SOC between the battery modules is suppressed. In addition, the damage or deterioration of the battery module is suppressed. Details of the system control unit 130 will be described below.

Each unit of the system control unit 130 or the system control unit 130 may be constituted by an analog circuit, may be constituted by a digital circuit, or may be constituted by a combination of an analog circuit and a digital circuit. The system control unit 130 may be implemented by hardware, may be implemented by software, or may be implemented by a combination of hardware and software.

In a case where at least a part of the components constituting the system control unit 130 is implemented by software, in an information processing device having a general configuration, the components implemented by the software may be implemented by starting software or a program which defines an operation relating to the components. The above-described information processing device having a general configuration may include a data processing device including a processor, a ROM, a RAM, a communication interface, and the like, an input device, an output device, and a storage device (including an external storage device).

In this embodiment, the power transmission bus 140 transmits electric power between any battery modules. When it is not needed to transmit electric power between any battery modules, the low potential bus 142 and the high potential bus 144 may be electrically insulated. When electric power is transmitted between any battery modules, the low potential bus 142 and the high potential bus 144 may be electrically connected. A timing to transmit electric power between any battery modules is decided by, for example, the system control unit 130.

In this embodiment, the low potential bus 142 is electrically connected to the negative electrode terminal of each of the battery module 112, the battery module 114, and the battery module 116. In this embodiment, the high potential bus 144 is electrically connected to the positive electrode terminal of each of the battery module 112, the battery module 114, and the battery module 116. Details of the connection between the low potential bus 142 and the high potential bus 144 and each battery module will be described below.

The battery pack 100 may be an example of a power storage system. The battery module 112 may be an example of a first assembled battery. The battery module 114 may be an example of a second assembled battery. The battery module 116 may be an example of the second assembled battery. The system control unit 130 may be an example of a detection unit, an opening/closing control unit, or a control device. The low potential bus 142 may be an example of a second power line. The high potential bus 144 may be an example of a first power line.

The transmission/reception of electric power via the power transmission bus 140 may be an example of transmission/reception of electric power via a power transmission/reception unit. The abnormality regarding the inter-battery module equalization operation may be an example of an abnormality regarding power transmission or power reception of the power transmission/reception unit.

### One Example of Another Embodiment

In this embodiment, for simplicity of description, an example of the battery pack 100 has been described by taking, as an example, a case where the battery pack 100 has three battery modules. However, the battery pack 100 is not limited by this embodiment.

In another embodiment, the battery pack 100 may include two battery modules. For example, the battery pack 100 includes the battery module 112 and the battery module 114 or the battery module 116.

In still another embodiment, the battery pack 100 may include four or more battery modules. For example, the battery pack 100 includes a single battery module 112, two or more battery modules 114, and one or more battery modules 116. The battery pack 100 may include a single battery module 112, one or more battery modules 114, and two or more battery modules 116.

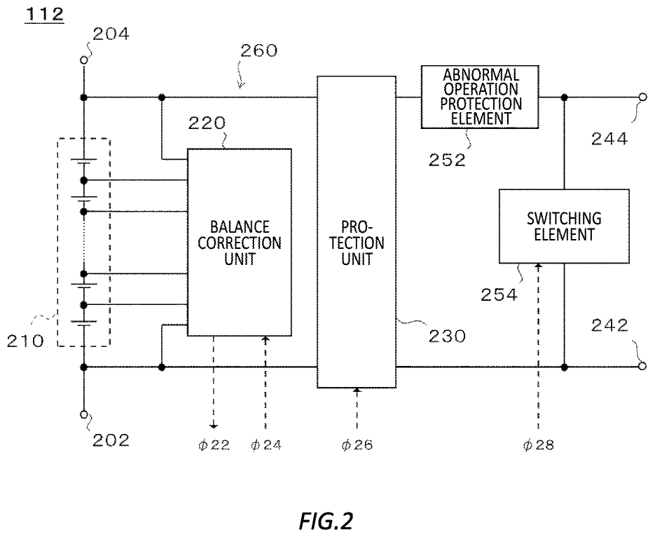

FIG. 2 schematically shows an example of the internal configuration of the battery module 112. In this embodiment, the battery module 112 includes a terminal 202, a terminal 204, an assembled battery 210, a balance correction unit 220, a protection unit 230, a terminal 242, and a terminal 244. In this embodiment, the battery module 112 includes an abnormal operation protection element 252 and a switching element 254. According to this embodiment, the terminal 204, the abnormal operation protection element 252, the switching element 254, and the terminal 202 form a circuit 260.

In this embodiment, the terminal 202 is electrically connected to the terminal 102. In addition, the terminal 202 is electrically connected to the negative electrode end of the assembled battery 210. In this embodiment, the terminal 204 is electrically connected to the terminal on the negative electrode side of the battery module 114. As described above, in this embodiment, the terminal 102, the battery module 112, the battery module 114, the battery module 116, and the terminal 104 are connected in series. In this manner, the terminal 204 is electrically connected to the terminal 104.

In this embodiment, the battery module 112 transmits/receives electric power to/from external equipment via the terminal 102 and the terminal 104, and the terminal 202 and the terminal 204. In addition, the battery module 112 transmits/receives electric power to/from the power transmission bus 140 via the terminal 242 and the terminal 242.

In this embodiment, the assembled battery 210 includes a plurality of power storage cells. In this embodiment, one end on the negative electrode side (which may be referred to as a negative electrode end) of the assembled battery 210 is electrically connected to the terminal 202, and one end on the positive electrode side (which may be referred to as a positive electrode end) of the assembled battery 210 is electrically connected to the terminal 204.

The power storage cells constituting the assembled battery 210 may be secondary batteries or capacitors. Examples of the types of the secondary batteries include a lithium battery, a lithium-ion battery, a lithium-sulfur battery, a sodium-sulfur battery, a lead-acid battery, a nickel-hydrogen battery, a nickel-cadmium battery, a redox flow battery, a metal-air battery, and the like. The types of the lithium-ion batteries are not particularly limited. Examples of the types of the lithium-ion batteries include an iron phosphate based battery, a manganese based battery, a cobalt based battery, a nickel based battery, a ternary based battery, and the like.

The power storage cells constituting the assembled battery 210 may further include a plurality of power storage cells. In an embodiment, a single power storage cell includes a plurality of power storage cells connected in series. In another embodiment, a single power storage cell includes a plurality of power storage cells connected in parallel. In still another embodiment, a single power storage cell includes a plurality of power storage cells connected in a matrix manner.

In this embodiment, the balance correction unit 220 equalizes the voltages or SOCs of a plurality of power storage cells included in the assembled battery 210. In an embodiment, the balance correction unit 220 equalizes the voltages or SOCs of any two power storage cells included in the assembled battery 210 by transferring charges between the two power storage cells. In another embodiment, the balance correction unit 220 equalizes the voltages or SOCs of any two power storage cells included in the assembled battery 210 by discharging one of the two power storage cells.

The balance correction unit 220 may transmit/receive information to/from the system control unit 130. For example, the balance correction unit 220 transmits, to the system control unit 130, a signal 22 indicating the state of the battery module 112. Examples of the state of a battery module include an operating state of the battery module, a voltage or SOC of the battery module, a magnitude and/or a direction of current flowing in the battery module, a voltage or SOC of each of a plurality of power storage cells included in the assembled battery 210 of the battery module, an operating state of the balance correction unit 220, and the like. Examples of the operating state of the battery module include charging, discharging, stopped, and the like. Examples of the operating state of the balance correction unit 220 include operating, stopped, and the like.

The balance correction unit 220 may receive, from the system control unit 130, a signal 24 for controlling the operation of the battery module 112. For example, the balance correction unit 220 receives, from the system control unit 130, the signal 24 for controlling an operation of equalizing voltages or SOCs of two power storage cells (which may be referred to as an inter-power storage cell equalization operation). Examples of the signal 24 for controlling the inter-power storage cell equalization operation include a signal for enabling the inter-power storage cell equalization operation, a signal for disabling the inter-power storage cell equalization operation, and the like.

The balance correction unit 220 may be configured to be able to perform the inter-power storage cell equalization operation without receiving the signal 24 from the system control unit 130. For example, the balance correction unit 220 is configured to be able to detect a difference in voltage or SOC between two power storage cells by a detection circuit arranged inside the balance correction unit 220 and transfer charges between the two power storage cells based on the difference.

The protection unit 230 protects the assembled battery 210 from at least one of overcurrent, overvoltage, overcharge, or overdischarge. A specific circuit configuration of the protection unit 230 is not particularly limited, and the protection unit 230 may include a known overcurrent protection circuit, may include a known overvoltage protection circuit, may include a known overcharge protection circuit, or may include a known overdischarge protection circuit. For example, a known overcurrent/overvoltage protection circuit such as disclosed in Japanese Patent Application Publication No. 2009-183141 can be used as the protection unit 230.

In an embodiment, the protection unit 230 executes an operation for protecting the assembled battery 210, based on a signal 26 from the outside. The protection unit 230 may receive the signal 26 from the system control unit 130 or may receive the signal 26 from the balance correction unit 220. In another embodiment, the protection unit 230 executes the operation for protecting the assembled battery 210, based on outputs of various detection circuits arranged inside the protection unit 230. In this case, the protection unit 230 may not receive the signal 26 from the outside. In addition, the signal 26 may be a signal from various detection circuits arranged inside the above-described protection unit 230.

In the embodiment shown in FIG. 2, the arrangement of the protection unit 230 is described by taking, as an example, a case where the protection unit 230 has elements arranged in series between the terminal 242 and/or the terminal 244 and the assembled battery 210. However, the protection unit 230 is not limited to this embodiment. In another embodiment, the protection unit 230 includes elements arranged in series between the terminal 202 and/or the terminal 204 and the assembled battery 210.

In an embodiment, the protection unit 230 controls an operation of the switching elements arranged in series between the terminal 202 and/or the terminal 204 and the assembled battery 210 (not shown) or a current limiting element having a reset function or a return function, based on the output of at least one of a circuit for detecting low voltage of the assembled battery 210 (not shown), a circuit for detecting overvoltage of the assembled battery 210 (not shown), or a circuit for detecting overcurrent of the assembled battery 210 (not shown). For example, when at least one of the low voltage, the overvoltage, or the overcurrent is detected, the protection unit 230 turns off the switching element or the current limiting element.

In another embodiment, the protection unit 230 controls an operation of the switching elements arranged in series between the terminal 242 and/or the terminal 244 and the assembled battery 210 (not shown) or a current limiting element having a reset function or a return function (not shown), based on the output of at least one of a circuit for detecting low voltage of the assembled battery 210 (not shown), a circuit for detecting overvoltage of the assembled battery 210 (not shown), or a circuit for detecting overcurrent of the assembled battery 210 (not shown). For example, when at least one of the low voltage, the overvoltage, or the overcurrent is detected, the protection unit 230 turns off the switching element or the current limiting element.

In this embodiment, the terminal 242 is electrically connected to the low potential bus 142. In addition, the terminal 242 is electrically connected to the negative electrode end of the assembled battery 210. In this embodiment, the terminal 244 is electrically connected to the high potential bus 144. In addition, the terminal 244 is electrically connected to the positive electrode end of the assembled battery 210. In this embodiment, the positive electrode end and negative electrode end of the assembled battery 210 in the battery module 112 are physically connected to the power transmission bus 140. In this manner, the positive electrode end and negative electrode end of the assembled battery 210 in the battery module 112 are always electrically connected to the power transmission bus 140.

According to this embodiment, the assembled battery 210 in the battery module 112 can transmit/receive electric power to/from at least one of the other battery modules via the terminal 242 and the terminal 244 and the power transmission bus 140. According to this embodiment, for example, the terminal 242 and the terminal 244, without disconnecting or shifting an electrical connection between (a) the assembled battery 210 and (b-1) a load which uses electric power of the assembled battery 210 or (b-2) a charging device which charges the assembled battery 210, (i) transmit electric power of the assembled battery 210 to at least one of the battery module 114 or the battery module 116, or (ii) receive electric power supplied to the assembled battery 210 from at least one of the battery module 114 or the battery module 116.

In this embodiment, the abnormal operation protection element 252 protects the battery module 112 from an abnormality regarding power transmission or power reception via the power transmission bus 140. For example, the abnormal operation protection element 252 protects the assembled battery 210 from the abnormality regarding the power transmission or power reception via the power transmission bus 140. In this manner, for example, the assembled battery 210 is protected from at least one of overcurrent, overvoltage, overcharge, or overdischarge.

Examples of the abnormal operation protection element 252 include at least one of a fuse, an electronic fuse (which may be referred to as E-fuse), a positive temperature coefficient (PTC) thermistor, or a switching element. The fuse may have a reset function or a return function, or may not have the reset function or the return function. In the electronic fuse, one or more semiconductor switches can realize an overcurrent shut-down function by a conventional glass tube fuse or a PTC thermistor. The electronic fuse may further include at least one function of an overvoltage protection function, a low-voltage protection function, or a thermal shutdown function in addition to the overcurrent protection function.

More specifically, in this embodiment, the abnormal operation protection element 252 is arranged between the positive electrode end or the terminal 204 of the assembled battery 210 and the high potential bus 144 or the terminal 244. In addition, the abnormal operation protection element 252 limits transmission/reception of electric power via the power transmission bus 140 between the battery module 112 and the battery module 114 or the battery module 116.

In an embodiment, the abnormal operation protection element 252 limits transmission/reception of electric power via the power transmission bus 140 by reducing the current flowing into the battery module 112 from the battery module 114 or the battery module 116 via the high potential bus 144. In another embodiment, the abnormal operation protection element 252 limits the transmission/reception of electric power via the power transmission bus 140 by shutting down the current flowing into the battery module 112 from the battery module 114 or the battery module 116 via the high potential bus 144.

In this embodiment, the abnormal operation protection element 252 constitutes a part of the circuit 260. As described above, the circuit 260 is configured to return from the positive electrode end of the assembled battery 210 to the negative electrode end of the assembled battery 210 through the abnormal operation protection element 252 and the switching element 254. The circuit 260 is opened and closed by the operation of the switching element 254. In addition, the operation of the switching element 254 is controlled by, for example, a signal 28 from the system control unit 130.

According to this embodiment, when the switching element 254 is turned on, the circuit 260 is short-circuited, and the abnormal operation protection element 252 limits the transmission/reception of electric power via the power transmission bus 140. On the other hand, when the switching element 254 is turned off, the above-described limitation may be released by the abnormal operation protection element 252. For example, in a case where the abnormal operation protection element 252 has the reset function or the return function, the above-described limitation is released when the switching element 254 is turned off.

When the abnormality regarding the power transmission or power reception via the power transmission bus 140 has occurred, the abnormal operation protection element 252 may limit the transmission/reception of electric power via the power transmission bus 140. When the abnormality regarding the power transmission or power reception via the power transmission bus 140 is detected, the abnormal operation protection element 252 may limit the transmission/reception of electric power via the power transmission bus 140.

In an embodiment, when at least one direction of the current flowing in the low potential bus 142, the current flowing in the high potential bus 144, or the output current from the battery module 114 or the battery module 116 to the power transmission bus 140 is different from a predetermined direction, it is determined that the abnormality regarding the power transmission or power reception via the power transmission bus 140 has occurred. In this manner, the above-described abnormality is detected.

As described below, the battery module 114 or the battery module 116 transmits/receives electric power to/from external equipment via the terminal 102 and the terminal 104. In addition, the battery module 114 or the battery module 116 includes a DC-DC converter, and transmits/receives electric power to/from the power transmission bus 140 via the DC-DC converter. The direction of the above-described output current is reversed between a case where the current flows from the battery module 114 or the battery module 116 to the power transmission bus 140 and a case where the current flows from the power transmission bus 140 to the battery module 114 or the battery module 116.

In another embodiment, when the magnitude of the current flowing into the battery module 112 from the high potential bus 144 is larger than a predetermined value, it is determined that the abnormality regarding the power transmission or power reception via the power transmission bus 140 has occurred. In this manner, the above-described abnormality is detected.

In another embodiment, when the magnitude of the current flowing out to the low potential bus 142 from the battery module 112 is larger than a predetermined value, it is determined that the abnormality regarding the power transmission or power reception via the power transmission bus 140 has occurred. In this manner, the above-described abnormality is detected.

In still another embodiment, when an operation regarding power transmission or power reception via the power transmission bus 140 of the battery module 114 or the battery module 116 is different from a predetermined operation, it is determined that the abnormality regarding the power transmission or power reception via the power transmission bus 140 has occurred. In this manner, the above-described abnormality is detected.

Examples of the predetermined operation include an operation commanded by the system control unit 130 to the battery module 114 or the battery module 116 with respect to the power transmission or power reception via the power transmission bus 140. In this manner, with respect to the power transmission or power reception via the power transmission bus 140, when the operation which is to be currently performed by the battery module 114 or the battery module 116 is different from the operation which is actually being performed by the battery module 114 or the battery module 116, the above-described abnormality is detected.

For example, when the system control unit 130 detects the abnormality regarding the power transmission or power reception via the power transmission bus 140, the abnormal operation protection element 252 limits the transmission/reception of electric power via the power transmission bus 140. More specifically, when the above-described abnormality is not detected, the circuit 260 is open, and the circuit 260 is not short-circuited. Here, when the system control unit 130 detects the above-described abnormality, the system control unit 130 transmits the signal 28 for closing the circuit 260 to the switching element 254. When receiving the signal 28, the switching element 254 closes the circuit 260 in accordance with the signal 28. In this manner, the circuit 260 is short-circuited, and large current flows in the abnormal operation protection element 252. According to this embodiment, when the magnitude of the current flowing in the abnormal operation protection element 252 becomes larger than a predetermined value, the resistance of the abnormal operation protection element 252 increases, or the abnormal operation protection element 252 shuts down the circuit 260. As a result, the transmission/reception of electric power via the power transmission bus 140 is limited.

In this embodiment, the switching element 254 opens and closes the circuit 260. For example, when no abnormality regarding the power transmission or power reception via the power transmission bus 140 is detected, the switching element 254 opens the circuit 260. When the abnormality regarding the power transmission or power reception via the power transmission bus 140 is detected, the switching element 254 closes the circuit 260. In this embodiment, the switching element 254 opens and closes the circuit 260 in accordance with the signal 28 from the system control unit 130.

The type of the switching element 254 is not particularly limited, but examples of the switching element 254 include a mechanical switch, a semiconductor switch, and the like. Examples of the semiconductor switch include a transistor, a thyristor, a triac, and the like. Examples of the transistor include a bipolar transistor (BJT), a field effect transistor (FET), and the like.

In this embodiment, the circuit 260 connects the terminal 204, the abnormal operation protection element 252, the switching element 254, and the terminal 202 in series. As described above, when the switching element 254 closes the circuit 260, the circuit 260 is short-circuited.

The terminal 202 of the battery module 112 may be an example of a negative electrode terminal of a first assembled battery. The negative electrode end of the assembled battery 210 of the battery module 112 may be an example of a negative electrode terminal of the first assembled battery. The terminal 204 of the battery module 112 may be an example of a positive electrode terminal of the first assembled battery. The positive electrode end of the assembled battery 210 of the battery module 112 may be an example of a positive electrode terminal of the first assembled battery. The assembled battery 210 of the battery module 112 may be an example of the first assembled battery. A plurality of power storage cells included in the assembled battery 210 of the battery module 112 may be an example of a plurality of first power storage cells. The balance correction unit 220 of the battery module 112 may be an example of a first equalization unit. The abnormal operation protection element 252 may be an example of a limitation unit. The switching element 254 may be an example of an opening/closing unit. The circuit 260 may be an example of a short circuit.

The direction of at least one of the current flowing in the low potential bus 142, the current flowing in the high potential bus 144, or the output current of the battery module 114 or the battery module 116 may be an example of the direction of the current in at least one of the first power line, the second power line, or the power transmission/reception unit. The current flowing into the battery module 112 from the battery module 114 or the battery module 116 via the high potential bus 144 may be an example of the current flowing into the first assembled battery from the second assembled battery via the power transmission/reception unit and the first power line. The operation regarding the power transmission or power reception via the power transmission bus 140 of the battery module 114 or the battery module 116 may be an example of the operation of the power transmission/reception unit.

### One Example of Another Embodiment

In this embodiment, an example of the battery module 112 has been described by taking, as an example, a case where the abnormal operation protection element 252 is arranged between the positive electrode end or the terminal 204 of the assembled battery 210 and the high potential bus 144 or the terminal 244. However, the battery module 112 is not limited to this embodiment. In another embodiment, the abnormal operation protection element 252 may be arranged between the negative electrode end or the terminal 202 of the assembled battery 210 and the low potential bus 142 or the terminal 242.

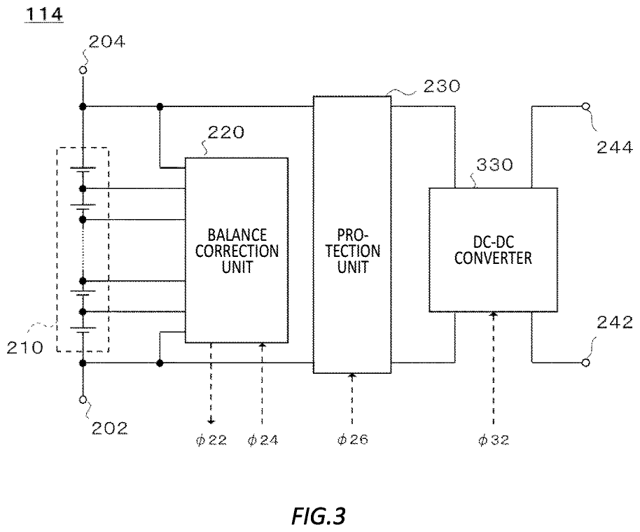

FIG. 3 schematically shows an example of the internal configuration of the battery module 114. In this embodiment, the battery module 114 includes the terminal 202, the terminal 204, the assembled battery 210, the balance correction unit 220, the protection unit 230, a DC-DC converter 330, the terminal 242, and the terminal 244. Note that the battery module 116 may have a similar internal configuration to the battery module 114.

In this embodiment, the battery module 114 is different from the battery module 242 in that (i) the DC-DC converter 330 is provided, (ii) the DC-DC converter 330 has the terminal 112 and the terminal 244, (iii) the terminal 242 and the negative electrode end or the terminal 202 of the assembled battery 210 are not physically connected, (iv) the terminal 244 and the positive electrode end or the terminal 204 of the assembled battery 210 are not physically connected, and (v) the abnormal operation protection element 252 and the switching element 254 are not provided. In the battery module 114, features other than the above-described differences may have a similar configuration to the battery module 112.

In this embodiment, the negative electrode end or the terminal 202 of the assembled battery 210 and the low potential bus 142 or the terminal 242 are electrically connected via the DC-DC converter 330. The positive electrode end or the terminal 204 of the assembled battery 210 and the high potential bus 144 or the terminal 244 are electrically connected via the DC-DC converter 330.

In this embodiment, the DC-DC converter 330 transmits/receives electric power between the assembled battery 210 in the battery module 114 and at least one of the other battery modules via the power transmission bus 140. For example, the DC-DC converter 330, without disconnecting or shifting an electrical connection between (a) the assembled battery 210 and (b-1) a load which uses electric power of the assembled battery 210 or (b-2) a charging device which charges the assembled battery 210, (i) transmits electric power of the assembled battery 210 to at least one of the battery module 112 or the battery module 116, or (ii) receives electric power supplied to the assembled battery 210 from at least one of the battery module 112 or the battery module 116. The DC-DC converter 330 may adjust, to any value, the voltage of the electric power to be transmitted or received.

In this embodiment, the DC-DC converter 330 may start the power transmission or power reception in response to receiving a signal for starting power transmission or power reception. The DC-DC converter 330 may stop the power transmission or power reception in response to receiving a signal for stopping power transmission or power reception. For example, the DC-DC converter 330 starts the power transmission or power reception or stops the power transmission or power reception, based on a signal 32 from the system control unit 130. The signal 32 may be a signal including information indicating to start an operation and information indicating whether to perform a power transmission operation or to perform a power reception operation. The signal 32 may be a signal indicating to start the power transmission operation. The signal 32 may be a signal indicating to start the power reception operation. The signal 32 may be information indicating to stop the operation currently performed.

The details of the DC-DC converter 330 are not particularly limited, and the DC-DC converter 330 may be an insulated DC-DC converter 330. The DC-DC converter 330 may be a bidirectional DC-DC converter. The battery module 114 may include a plurality of DC-DC converters 330.

The DC-DC converter 330 may be a forward DC-DC converter, or may be a flyback DC-DC converter. In the battery pack 100, the battery module 112, the battery module 114, and the battery module 116 may have different rated voltages. Therefore, the DC-DC converter 330 is preferably a flyback DC-DC converter having a wide range of available voltage.

The DC-DC converter 330 may be a self-commutated DC-DC converter, or may be an externally-commutated DC-DC converter. The DC-DC converter 330 may be an asynchronous-rectification DC-DC converter, or may be a synchronous-rectification DC-DC converter. A method of controlling the DC-DC converter 330 is not particularly limited, but it is preferable to perform a constant-current control. Details of an embodiment of the DC-DC converter 330 will be described below.

The terminal 202 of the battery module 114 or the battery module 116 may be an example of a negative electrode terminal of the second assembled battery. The negative electrode end of the assembled battery 210 of the battery module 114 or the battery module 116 may be an example of the negative electrode terminal of the second assembled battery. The terminal 204 of the battery module 114 or the battery module 116 may be an example of a positive electrode terminal of the second assembled battery. The positive electrode end of the assembled battery 210 of the battery module 114 or the battery module 116 may be an example of the positive electrode terminal of the second assembled battery. The assembled battery 210 of the battery module 114 or the battery module 116 may be an example of the second assembled battery. A plurality of power storage cells included in the assembled battery 210 of the battery module 114 or the battery module 116 may be an example of a plurality of second power storage cells. The balance correction unit 220 of the battery module 114 or the battery module 116 may be an example of a second equalization unit. The DC-DC converter 330 may be an example of a power transmission/reception unit.

### One Example of Another Embodiment

The battery module 112 described in relation to FIG. 2 does not include the DC-DC converter 330. However, the battery module 112 is not limited by the above-described embodiment. The battery module 112 may have a similar configuration to the battery module 114. It is preferable that at least one of the battery module 112, the battery module 114, or the battery module 116 includes a bidirectional DC-DC converter.

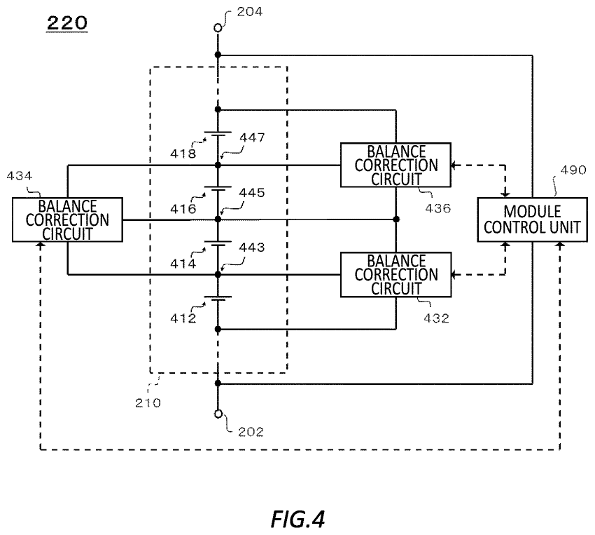

FIG. 4 schematically shows an example of the internal configuration of the balance correction unit 220. FIG. 4 shows an example of the internal configuration of the balance correction unit 220, together with the terminal 202, the terminal 204 and the assembled battery 210. In this embodiment, the assembled battery 210 is constituted of a plurality of power storage cells connected in series, including a power storage cell 412, a power storage cell 414, a power storage cell 416 and a power storage cell 418. In this embodiment, the balance correction unit 220 includes a plurality of balance correction circuits including a balance correction circuit 432, a balance correction circuit 434 and a balance correction circuit 436. In this embodiment, the balance correction unit 220 includes a module control unit 490.

In this embodiment, the balance correction circuit 432 equalizes the voltages of the power storage cell 412 and the power storage cell 414. In this embodiment, the balance correction circuit 432 is electrically connected to one end on the terminal 204 side (which may be referred to as a positive electrode side) of the power storage cell 414. The balance correction circuit 432 is electrically connected to a connection point 443 between one end on the terminal 202 side (which may be referred to as a negative electrode side) of the power storage cell 414 and the positive electrode side of the power storage cell 412. The balance correction circuit 432 is electrically connected to the negative electrode side of the power storage cell 412.

This embodiment describes a case where the balance correction circuit 432 equalizes the voltages of two adjacent power storage cells. However, the balance correction circuit 432 is not limited by this embodiment. In another embodiment, the balance correction circuit 432 may equalize the voltages of any two power storage cells among three or more power storage cells connected in series.

In this embodiment, the balance correction circuit 434 equalizes the voltages of the power storage cell 414 and the power storage cell 416. The balance correction circuit 434 is electrically connected to the connection point 443, a connection point 445 between the positive electrode side of the power storage cell 414 and the negative electrode side of the power storage cell 416, and a connection point 447 between the positive electrode side of the power storage cell 416 and the negative electrode side of the power storage cell 418. The balance correction circuit 434 may have a similar configuration to the balance correction circuit 432.

In this embodiment, the balance correction circuit 436 equalizes the voltages of the power storage cell 416 and the power storage cell 418. The balance correction circuit 436 is electrically connected to the connection point 445, the connection point 447, and the positive electrode side of the power storage cell 418. The balance correction circuit 436 may have a similar configuration to the balance correction circuit 432.

In this embodiment, the module control unit 490 controls the operation of the battery module on which the module control unit 490 is mounted. The module control unit 490 may be driven by using the electric power of the assembled battery 210.

For example, the module control unit 490 controls the balance correction circuit 432, the balance correction circuit 434, and/or the balance correction circuit 436. In an embodiment, the module control unit 490 decides a direction to transfer charges. For example, the module control unit 490 decides a direction to transfer charges, based on voltages or SOCs of two power storage cells to be subjected to the inter-cell equalization operation. The module control unit 490 may transmit a signal, which includes information indicating the direction to transfer charges, to the corresponding balance correction circuit. In another embodiment, the module control unit 490 decides whether to operate each balance correction circuit. In addition, the module control unit 490 decides whether to stop each balance correction circuit. The module control unit 490 may transmit a signal, which includes information indicating the operation or stop of each balance correction circuit, to the corresponding balance correction circuit.

In this embodiment, the module control unit 490 collects information regarding the state of the assembled battery 210 and/or the balance correction unit 220. The module control unit 490 may transmit, to the system control unit 130, the information regarding the state of the assembled battery 210 and/or the balance correction unit 220. For example, the module control unit 490 transmits information indicating the voltage of each of the plurality of power storage cells, to the system control unit 130. For example, the module control unit 490 transmits information indicating the inter-terminal voltage of the assembled battery 210, to the system control unit 130. For example, the module control unit 490 transmits information indicating the operation status of each balance correction circuit, to the system control unit 130.

The power storage cell 412 may be an example of a first power storage cell or a second power storage cell. The power storage cell 414 may be an example of the first power storage cell or the second power storage cell. The power storage cell 416 may be an example of the first power storage cell or the second power storage cell. The power storage cell 418 may be an example of the first power storage cell or the second power storage cell. The balance correction circuit 432 may be an example of the first equalization unit or the second equalization unit. The balance correction circuit 434 may be an example of the first equalization unit or the second equalization unit. The balance correction circuit 436 may be an example of the first equalization unit or the second equalization unit.

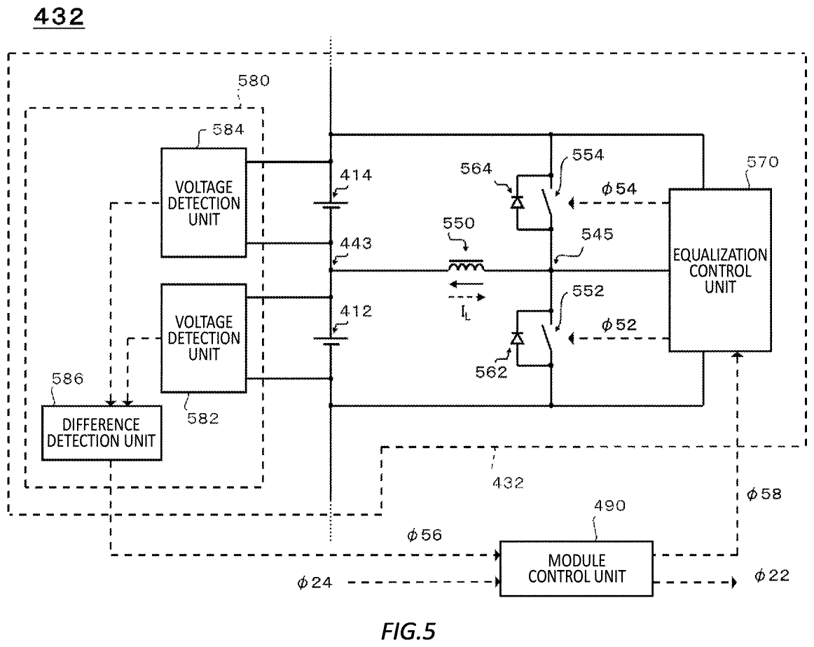

FIG. 5 schematically shows an example of the internal configuration of the balance correction circuit 432. FIG. 5 shows an example of the internal configuration of the balance correction circuit 432, together with the power storage cell 412, the power storage cell 414, and the module control unit 490. Note that the balance correction circuit 434 and the balance correction circuit 436 may also have a similar internal configuration to the balance correction circuit 432.

In this embodiment, the balance correction circuit 432 includes an inductor 550, a switching element 552, a switching element 554 and an equalization control unit 570. The balance correction circuit 432 may include a diode 562 and a diode 564. The balance correction circuit 432 may include a voltage monitoring unit 580. The voltage monitoring unit 580 includes, for example, a voltage detection unit 582, a voltage detection unit 584 and a difference detection unit 586.

The equalization control unit 570, and the switching element 554 and the switching element 552 may be arranged on physically the same substrate, or may be arranged on physically different substrates. The equalization control unit 570 and the module control unit 490 may be formed on physically the same substrate, or may be formed on physically different substrates.

This embodiment describes a case where (i) a resistor provided at an appropriate position in a first circuit including the power storage cell 414, the inductor 550, and the switching element 554 or the diode 564, and (ii) a resistor provided at an appropriate position in a second circuit including the power storage cell 412, the inductor 550, and the switching element 552 or the diode 562 are used as a current detection unit for detecting inductor current flowing in the inductor 550. The above-described resistors may be shunt resistors.

However, the current detection unit is not limited by this embodiment. In another embodiment, at least one of the internal resistance of the switching element 552 or the internal resistance of the switching element 554 may be used as the current detection unit. In still another embodiment, the current detection unit may be an ammeter which detects current flowing in the inductor 550 and transmits a signal including information indicating the current value of the inductor 550 to the equalization control unit 570.

In this embodiment, the balance correction circuit 432 is electrically connected to (i) the positive electrode side of the power storage cell 414, (ii) the connection point 443 between the negative electrode side of the power storage cell 414 and the positive electrode side of the power storage cell 412 and (iii) the negative electrode side of the power storage cell 412. In this manner, a first open/close circuit including the power storage cell 414, the switching element 554 and the inductor 550 is formed. In addition, a second open/close circuit including the power storage cell 412, the inductor 550 and the switching element 552 is formed.

In this embodiment, the inductor 550 is arranged between the power storage cell 414 and the switching element 554, and connected in series to the power storage cell 414 and the switching element 554. In this manner, the inductor 550 and the switching element 554 cooperate to adjust the voltage or SOC of at least one of the power storage cell 412 or the power storage cell 414. In this embodiment, one end of the inductor 550 is electrically connected to the connection point 443. The other end of the inductor 550 is electrically connected to a connection point 545 between the switching element 552 and the switching element 554.

According to this embodiment, the switching element 552 and the switching element 554 are alternately and repeatedly turned on and off (which may be referred to as “turned on/off”), and thereby an inductor current I_{L} is generated in the inductor 550. In this manner, electrical energy can be transferred between the power storage cell 412 and the power storage cell 414 via the inductor 550. As a result, the voltages of the power storage cell 412 and the power storage cell 414 can be equalized.

In this embodiment, the switching element 552 is electrically connected between the other end of the inductor 550 and the negative electrode side of the power storage cell 412. The switching element 552 receives a drive signal 52 from the equalization control unit 570, and is turned on or off based on the drive signal 52. The second open/close circuit is opened/closed in association with the operation of the switching element 552. The switching element 552 may be a semiconductor transistor such as a MOSFET.

In this embodiment, the switching element 554 is electrically connected between the other end of the inductor 550 and the positive electrode side of the power storage cell 414. The switching element 554 receives a drive signal 54 from the equalization control unit 570, and is turned on or off based on the drive signal 54. The first open/close circuit is opened/closed in association with the operation of the switching element 554. The switching element 554 may be a semiconductor transistor such as a MOSFET.

In this embodiment, the diode 562 is electrically connected between the other end of the inductor 550 and the negative electrode side of the power storage cell 412. The diode 562 is arranged in parallel with the switching element 552. If the switching element 552 is a semiconductor element such as a MOSFET, the diode 562 may be a parasitic diode which is equivalently formed between the source and drain of the switching element 552.

In this embodiment, the diode 562 passes current in a direction from the negative electrode side of the power storage cell 412 toward the other end of the inductor 550. On the other hand, the diode 562 does not pass current in a direction from the other end of the inductor 550 toward the negative electrode side of the power storage cell 412. That is, current flowing in a direction from the negative electrode side of the power storage cell 412 toward the positive electrode side of the power storage cell 412 can pass through the diode 562, while current flowing in a direction from the positive electrode side of the power storage cell 412 toward the negative electrode side of the power storage cell 412 cannot pass through the diode 562.

In this embodiment, the diode 564 is electrically connected between the other end of the inductor 550 and the positive electrode side of the power storage cell 414. The diode 564 is arranged in parallel with the switching element 554. If the switching element 554 is a semiconductor element such as a MOSFET, the diode 564 may be a parasitic diode which is equivalently formed between the source and drain of the switching element 554.

In this embodiment, the diode 564 passes current in a direction from the other end of the inductor 550 toward the positive electrode side of the power storage cell 414. On the other hand, the diode 564 does not pass current in a direction from the positive electrode side of the power storage cell 414 toward the other end of the inductor 550. That is, current flowing in a direction from the negative electrode side of the power storage cell 414 toward the positive electrode side of the power storage cell 414 can pass through the diode 564, while current flowing in a direction from the positive electrode side of the power storage cell 414 toward the negative electrode side of the power storage cell 414 cannot pass through the diode 564.

As the balance correction circuit 432 includes the diode 562 and the diode 564, even if the inductor current I_{L} remains in the first circuit or the second circuit during a period of time in which both the switching element 552 and the switching element 554 are turned off, the inductor current I_{L} can continue to flow in the circuit through the diode 562 or the diode 564. In this manner, the balance correction circuit 432 can fully use the inductor current I_{L} once generated in the inductor 550. In addition, the balance correction circuit 432 can suppress generation of a surge voltage when the inductor current I_{L} is shut down.

In this embodiment, the equalization control unit 570 controls the balance correction circuit 432 by controlling at least one of the switching element 552 or the switching element 554. For example, the equalization control unit 570 controls at least one of the switching element 552 or the switching element 554 based on a signal 58 from the module control unit 490. The signal 58 may have a similar configuration to the signal described in relation to FIG. 4 and transmitted from the module control unit 490 to the balance correction circuit.

In this embodiment, the equalization control unit 570 supplies the switching element 552 with the drive signal 52 for controlling the switching element 552 to be turned on/off. In addition, the equalization control unit 570 supplies the switching element 554 with the drive signal 54 for controlling the switching element 554 to be turned on/off.

In an embodiment, the equalization control unit 570 supplies the drive signal 52 and the drive signal 54 so that the switching element 552 and the switching element 554 are alternately (or in a complementary way) and repeatedly turned on/off. In this manner, while the balance correction circuit 432 is in operation, a switching operation is repeatedly performed to alternately switch between a state where current flows in the first circuit and a state where current flows in the second circuit.

In another embodiment, the equalization control unit 570 supplies the drive signal 52 and the drive signal 54 so that one of the switching element 552 and the switching element 554 is repeatedly turned on/off and the other of the switching element 552 and the switching element 554 stays turned off. In this manner, while the balance correction circuit 432 is in operation, a switching operation is repeatedly performed to alternately switch between a state where current flows in the first circuit and a state where current flows in the second circuit.

The equalization control unit 570 may generate various control signals used to control the balance correction circuit 432 by combining the drive signal 52 and the drive signal 54. In an embodiment, the equalization control unit 570 generates a first control signal for turning on the switching element 554 and turning off the switching element 552. In another embodiment, the equalization control unit 570 generates a second control signal for turning off the switching element 554 and turning on the switching element 552. In still another embodiment, the equalization control unit 570 generates a third control signal for turning off the switching element 554 and turning off the switching element 552. Each of the first control signal, the second control signal, and the third control signal may be configured by the drive signal 52 and the drive signal 54.

For example, the equalization control unit 570 controls the balance correction circuit 432 such that, while the balance correction circuit 432 operates, the balance correction circuit 432 repeatedly performs the following switching operation. The equalization control unit 570 may supply the drive signal 52 and the drive signal 54 to the switching element 552 and the switching element 554 so that the balance correction circuit 432 repeats the switching operation at a predetermined cycle during the operation period of the balance correction circuit 432. In addition, for example, the equalization control unit 570 controls the balance correction circuit 432 such that, while the balance correction circuit 432 stops, the balance correction circuit 432 stops the switching operation.

The switching operation may include (i) a first operation in which the switching element 554 is turned on and the switching element 552 is turned off, and (ii) a second operation in which the switching element 554 is turned off and the switching element 552 is turned on. The switching operation may include, in addition to the first operation and the second operation, a third operation in which both the switching element 554 and the switching element 552 are turned off. The order of the first operation, the second operation and the third operation may be arbitrarily decided, but it is preferable to perform the second operation following the first operation. The switching operation may include another operation that is different from the first operation, the second operation and the third operation described above.

In this embodiment, the voltage monitoring unit 580 monitors the voltage of at least one of the power storage cell 412 or the power storage cell 414. In this embodiment, the voltage monitoring unit 580 detects the voltage of the power storage cell 412 and the voltage of the power storage cell 414 by using the voltage detection unit 582 and the voltage detection unit 584. The voltage monitoring unit 580 inputs the voltage of the power storage cell 412 and the voltage of the power storage cell 414 to the difference detection unit 586, and detects the voltage difference between the power storage cell 412 and the power storage cell 414. The voltage monitoring unit 580 generates a signal 56 indicating the detected voltage difference and transmits the generated signal to the module control unit 490. The signal 56 may include information indicating whether the voltage of the power storage cell 412 or the voltage of the power storage cell 414 is larger. The signal 56 may include information indicating the voltage of the power storage cell 412 and the voltage of the power storage cell 414.

### One Example of Another Embodiment

This embodiment describes a case where the balance correction circuit 432 equalizes the voltages of the power storage cell 412 and the power storage cell 414 by using the inductor 550, the switching element 552, and the switching element 554. However, the balance correction circuit 432 is not limited by this embodiment. The balance correction circuit 432 may equalize the voltages of the power storage cell 412 and the power storage cell 414 in a known equalization manner or in an equalization manner to be developed in the future. In an embodiment, a balance correction circuit is used which releases energy of a power storage cell having a higher voltage by using resistance. In another embodiment, a balance correction circuit which transfers charges by using a transformer is used.

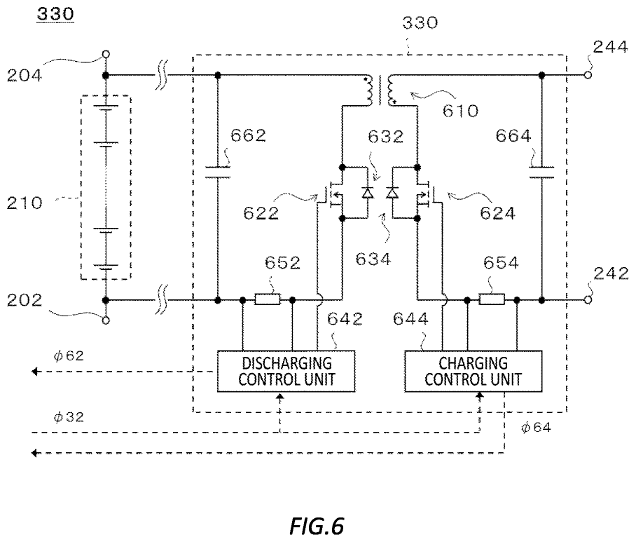

FIG. 6 schematically shows an example of the internal configuration of the DC-DC converter 330. In this embodiment, the DC-DC converter 330 includes a transformer 610. In this embodiment, the DC-DC converter 330 includes a switching element 622, a diode 634, a discharging control unit 642, a current detection unit 652 and a capacitor 662. In this manner, electric power of the assembled battery 210 can be supplied to another battery module.

In this embodiment, the DC-DC converter 330 includes a switching element 624, a diode 632, a charging control unit 644, a current detection unit 654 and a capacitor 664. In this manner, electric power supplied from another battery module can be used to charge the assembled battery 210.

In this embodiment, the transformer 610 includes two coils. The transformer 610 transmits energy from one coil to the other coil. In addition, the transformer 610 transmits energy from the other coil to one coil.

In this embodiment, one end of one coil in the transformer 610 is electrically connected to the positive electrode end of the assembled battery 210. The other end of one coil in the transformer 610 is electrically connected to one end of the switching element 622. The other end of the switching element 622 is electrically connected to the negative electrode end of the assembled battery 210.

In this embodiment, one end of the other coil in the transformer 610 is electrically connected to the terminal 244. The other end of the other coil in the transformer 610 is electrically connected to one end of the switching element 624. The other end of the switching element 624 is electrically connected to the terminal 242.

In this embodiment, the switching element 622 is turned on and off based on a signal from the discharging control unit 642. The switching element 622 may be a semiconductor transistor such as a MOSFET. In this embodiment, the switching element 624 is turned on and off based on a signal from the charging control unit 644. The switching element 622 may be a semiconductor transistor such as a MOSFET.

In this embodiment, the diode 632 is electrically connected between the other end of one coil in the transformer 610 and the negative electrode end of the assembled battery 210. The diode 632 is arranged in parallel with the switching element 622. If the switching element 622 is a semiconductor element such as a MOSFET, the diode 632 may be a parasitic diode which is equivalently formed between the source and drain of the switching element 622. In this embodiment, the diode 632 passes current in a direction from the negative electrode end of the assembled battery 210 toward the positive electrode end of the assembled battery 210. On the other hand, the diode 632 does not pass current in a direction from the positive electrode end of the assembled battery 210 toward the negative electrode end of the assembled battery 210.

In this embodiment, the diode 634 is electrically connected between the other end of the other coil in the transformer 610 and the terminal 242. The diode 634 is arranged in parallel with the switching element 624. If the switching element 624 is a semiconductor element such as a MOSFET, the diode 634 may be a parasitic diode which is equivalently formed between the source and drain of the switching element 624. In this embodiment, the diode 634 passes current in a direction from the terminal 242 toward the terminal 244. On the other hand, the diode 634 does not pass current in a direction from the terminal 244 toward the terminal 242.

In this embodiment, the discharging control unit 642 controls the switching element 622. For example, the discharging control unit 642 generates a signal for controlling the switching element 622 to be turned on and off, and transmits the generated signal to the switching element 622. The discharging control unit 642 may include a pulse width modulator. The discharging control unit 642 may generate the above-described signal by using the pulse width modulator.

In an embodiment, the discharging control unit 642 acquires information indicating the magnitude of the current flowing in the transformer 610 from the current detection unit 652. The discharging control unit 642 may generate, based on the information indicating the magnitude of the current flowing in the transformer 610, a signal for controlling the switching element 622 to be turned on and off.

For example, the discharging control unit 642 generates a signal for controlling the switching element 622 to be turned on and off such that the magnitude of the current flowing in one coil in the transformer 610 satisfies a predetermined condition. The predetermined condition may be a condition that the magnitude of the current flowing in one coil in the transformer 610 is substantially equal to the rated current value of the DC-DC converter 330.

In another embodiment, the discharging control unit 642 generates a signal for controlling the switching element 622 to be turned on and off such that the voltage between the terminal 242 and the terminal 244 satisfies a predetermined condition. Examples of the predetermined condition can include a condition that the voltage between the terminal 242 and the terminal 244 is substantially equal to a predetermined value, a condition that the voltage between the terminal 242 and the terminal 244 is within a predetermined range, and the like.

In this embodiment, the discharging control unit 642 transmits a signal 62, which includes information indicating the operation status of the discharging control unit 642, to the system control unit 130. Examples of the information indicating the operation status of the discharging control unit 642 include information indicating that the discharging control unit is operating, information indicating that the discharging control unit is stopped, information indicating an operation amount, and the like. The discharging control unit 642 may include a driving power supply (not shown), may be driven by using the electric power supplied from the assembled battery 210, or may be driven by using the electric power supplied from the power transmission bus 140.

In this embodiment, the charging control unit 644 controls the switching element 624. For example, the charging control unit 644 generates a signal for controlling the switching element 624 to be turned on and off, and transmits the generated signal to the switching element 624. The charging control unit 644 may include a pulse width modulator. The charging control unit 644 may generate the above-described signal by using the pulse width modulator.

In an embodiment, the charging control unit 644 acquires information indicating the magnitude of the current flowing in the transformer 610 from the current detection unit 654. The charging control unit 644 may generate, based on the information indicating the magnitude of the current flowing in the transformer 610, a signal for controlling the switching element 624 to be turned on and off.

For example, the charging control unit 644 generates a signal for controlling the switching element 624 to be turned on and off such that the magnitude of the current flowing in the other coil in the transformer 610 satisfies a predetermined condition. The predetermined condition may be a condition that the magnitude of the current flowing in the other coil in the transformer 610 is substantially equal to the rated current value of the DC-DC converter 330.

In another embodiment, the charging control unit 644 generates a signal for controlling the switching element 624 to be turned on and off such that the voltage applied to the assembled battery 210 satisfies a predetermined condition. Examples of the predetermined condition can include a condition that the voltage applied to the assembled battery 210 is substantially equal to a predetermined value, a condition that the voltage applied to the assembled battery 210 is within a predetermined range, and the like.

In this embodiment, the charging control unit 644 transmits a signal 64, which includes information indicating the operation status of the charging control unit 644, to the system control unit 130. Examples of the information indicating the operation status of the charging control unit 644 include information indicating that the charging control unit is operating, information indicating that the charging control unit is stopped, information indicating an operation amount, and the like. The charging control unit 644 may include a driving power supply (not shown), or may be driven by using the electric power supplied from the power transmission bus 140.

In this embodiment, the current detection unit 652 detects current flowing in one coil in the transformer 610. The current detection unit 652 provides the discharging control unit 642 with information indicating the magnitude of the detected current. In this embodiment, the current detection unit 654 detects current flowing in the other coil in the transformer 610. The current detection unit 654 provides the charging control unit 644 with information indicating the magnitude of the detected current.

In this embodiment, one end of the capacitor 662 is electrically connected to one end of one coil in the transformer 610. The other end of the capacitor 662 is electrically connected to the other end of the switching element 622. The capacitor 662 is arranged in parallel with the assembled battery 210. In this embodiment, one end of the capacitor 664 is electrically connected to one end of the other coil in the transformer 610. The other end of the capacitor 664 is electrically connected to the other end of the switching element 624. The capacitor 664 is arranged in parallel with the assembled battery 210 of the battery module 112 via the abnormal operation protection element 252 of the battery module 112.

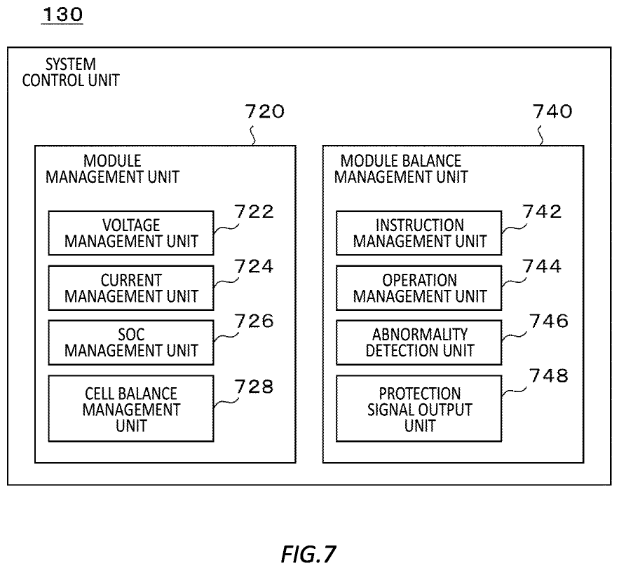

FIG. 7 schematically shows an example of the internal configuration of the system control unit 130. In this embodiment, the system control unit 130 includes a module management unit 720 and a module balance management unit 740. In this embodiment, the module management unit 720 includes a voltage management unit 722, a current management unit 724, an SOC management unit 726, and a cell balance management unit 728. In this embodiment, the module balance management unit 740 includes an instruction management unit 742, an operation management unit 744, an abnormality detection unit 746, and a protection signal output unit 748.

In this embodiment, the module management unit 720 manages the state of each of the battery module 112, the battery module 114, and the battery module 116. For example, the module management unit 720 acquires information indicating the state of each battery module. The module management unit 720 may acquire information indicating the state of the power storage cell arranged in each battery module.

For example, the module management unit 720 receives the signal 22, which includes information indicating the state of each battery module, from the module control unit 490 of each battery module. The module management unit 720 and each unit thereof store the information indicating the state of each battery module in a storage device (not shown).

In this embodiment, the voltage management unit 722 manages the voltage of each of the battery module 112, the battery module 114, and the battery module 116. The voltage management unit 722 may manage information indicating the magnitude of the voltage of each battery module. The voltage management unit 722 may manage information indicating time and the above-described information indicating the magnitude of voltage at the time in association with each other. Examples of the above-described voltage include the inter-terminal voltage of the assembled battery 210 and/or a potential difference between the terminal 242 and the terminal 244, and the like.

In this embodiment, the current management unit 724 manages the current flowing in the assembled battery 210 of each of the battery module 112, the battery module 114, and the battery module 116. The current management unit 724 may manage information indicating the magnitude of the current flowing in the assembled battery 210 of each battery module. The current management unit 724 may manage information indicating the direction of the current flowing in the assembled battery 210 of each battery module. The current management unit 724 may manage information indicating time and information indicating at least one of the magnitude or the direction of the above-described current at the time in association with each other.

In this embodiment, the SOC management unit 726 manages the SOC of the assembled battery 210 of each of the battery module 112, the battery module 114, and the battery module 116. The SOC management unit 726 may manage information indicating the magnitude of the SOC of each battery module. The SOC management unit 726 may manage information indicating time and the above-described information indicating the magnitude of SOC at the time in association with each other.

In this embodiment, the cell balance management unit 728 manages a plurality of power storage cells included in the assembled battery 210 of each of the battery module 112, the battery module 114, and the battery module 116. The cell balance management unit 728 may manage information regarding the above-described power storage cell. For example, the cell balance management unit 728 manages information indicating the voltage or SOC of each power storage cell.

The cell balance management unit 728 may manage the voltage or SOC of the power storage cell of each battery module by controlling the inter-power storage cell equalization operation in each battery module. For example, the cell balance management unit 728 generates the signal 24 for controlling the inter-power storage cell equalization operation in each battery module, based on the voltage or SOC of each power storage cell of each battery module. The cell balance management unit 728 may transmit the signal 24 to the target battery module.

In this embodiment, the module balance management unit 740 manages an equalization operation between at least two battery modules among the battery module 112, the battery module 114, and the battery module 116. The module balance management unit 740 manages the above-described equalization operation such that the voltages and/or SOCs of the battery module 112, the battery module 114, and the battery module 116 are substantially the same.

In this embodiment, the instruction management unit 742 manages an instruction regarding the equalization operation by the system control unit 130 for each battery module. For example, the instruction management unit 742 generates the signal 32 for controlling the operation of the DC-DC converter 330 arranged in at least one of the battery module 114 or the battery module 116, based on the voltage and/or SOC of each battery module acquired by the voltage management unit 722 and/or the SOC management unit 726. The instruction management unit 742 transmits the above-described signal 32 to the target battery module.

As described above, the battery module 114 and the battery module 116 transmit/receive electric power to/from the power transmission bus 140 via the DC-DC converter 330. The instruction management unit 742 can control transmission/reception of electric power between the battery module and the power transmission bus 140 by controlling the operation of the DC-DC converter 330 arranged in the above-described battery module.

On the other hand, in the battery module 112, the terminal 242 and the terminal 244 are physically connected to the power transmission bus 140. When the inter-terminal voltage of the assembled battery 210 is smaller than the potential difference between the terminal 242 and the terminal 244, the assembled battery 210 can be charged. In addition, when the inter-terminal voltage of the assembled battery 210 is larger than the potential difference between the terminal 242 and the terminal 244, the assembled battery 210 can be discharged. The instruction management unit 742 can control the operation of the DC-DC converter 330 arranged in the battery module 114 and/or the battery module 116 to control a potential difference between the low potential bus 142 and the high potential bus 144, thereby controlling transmission/reception of electric power between the battery module 112 and the power transmission bus 140.

More specifically, for example, the instruction management unit 742 generates a signal including at least one of (i) a command to cause the DC-DC converter 330 of the battery module which transmits electric power to the power transmission bus 140 to start a power transmission operation or (ii) a command to cause the DC-DC converter 330 of the battery module which receives electric power from the power transmission bus 140 to start a power reception operation. The instruction management unit 742 may generate the above-described signal based on the voltage or SOC of each of a plurality of power storage cells constituting each assembled battery 210 of each battery module. The instruction management unit 742 may generate the above-described signal based on the voltage or SOC of each assembled battery 210 of each battery module.

For example, the instruction management unit 742 generates a signal including at least one of (i) a command to cause the DC-DC converter 330 of the battery module which transmits electric power to the power transmission bus 140 to stop the power transmission operation or (ii) a command to cause the DC-DC converter 330 of the battery module which receives electric power from the power transmission bus 140 to stop the power reception operation. The instruction management unit 742 may generate the above-described signal based on the voltage or SOC of each of a plurality of power storage cells constituting each assembled battery 210 of each battery module. The instruction management unit 742 may generate the above-described signal based on the voltage or SOC of each assembled battery 210 of each battery module.

In this embodiment, the instruction management unit 742 manages information indicating the transmission destination of the above-described signal 32 and information indicating the content of the signal 32 in association with each other. In an embodiment, the instruction management unit 742 manages information indicating the time when the above-described signal 32 is transmitted, the information indicating the transmission destination of the above-described signal 32, and the information indicating the content of the signal 32 in association with each other. In another embodiment, the instruction management unit 742 manages identification information of each battery module and information indicating the content of the latest signal 32 for each battery module in association with each other.

In this embodiment, the operation management unit 744 manages the status of the inter-battery module equalization operation. For example, the operation management unit 744 manages the operation status of the DC-DC converter 330 arranged in the battery module 114 and the battery module 116. The operation management unit 744 may acquire information indicating the operation status of each of the above-described DC-DC converters 330 and manage the information.

For example, the operation management unit 744 acquires information indicating at least one of the magnitude of discharging voltage, the magnitude of discharging current, the direction of discharging current, the magnitude of charging voltage, the magnitude of charging current, or the direction of charging current for each of the above-described DC-DC converters 330, and manages the information. For example, the operation management unit 744 acquires information indicating the operation status of the discharging control unit 642 and/or the charging control unit 644 described above for each of the DC-DC converters 330, and manages the information.

In this embodiment, the abnormality detection unit 746 detects the abnormality regarding the inter-battery module equalization operation. For example, the abnormality detection unit 746 detects the abnormality of the DC-DC converter 330 arranged in the battery module 114 and the battery module 116. More specifically, the abnormality detection unit 746 detects the abnormality regarding the power transmission or power reception of the above-described DC-DC converter 330.

The abnormality detection unit 746 may detect the above-described abnormality based on various types of information managed by the module management unit 720. When the above-described abnormality is detected, the abnormality detection unit 746 may output, to the protection signal output unit 748, information indicating that the abnormality is detected.

In an embodiment, the abnormality detection unit 746 detects the above-described abnormality when the direction of current in at least one of the low potential bus 142, the high potential bus 144, or the DC-DC converter 330 is different from a predetermined direction. Examples of the predetermined direction include (i) a direction of current when the equalization operation determined by the instruction management unit 742 is normally performed, (ii) a direction decided based on the voltage or SOC of the battery module 112, and the like.

For example, when the voltage or SOC of the battery module 112 is larger than a predetermined value, a direction from the battery module 112 toward the power transmission bus 140 is decided as the above-described predetermined direction. Similarly, when the voltage or SOC of the battery module 112 is smaller than the predetermined value, a direction from the power transmission bus 140 toward the battery module 112 is decided as the above-described predetermined direction.

In another embodiment, the abnormality detection unit 746 detects the above-described abnormality when the magnitude of the current flowing into the battery module 112 from the high potential bus 144 is larger than a predetermined value. Examples of the predetermined value include (i) the magnitude of the current when the equalization operation determined by the instruction management unit 742 is normally performed, (ii) the magnitude of the current decided based on the voltage or SOC of the battery module 112, and the like.

For example, the predetermined value is decided such that the larger the voltage or SOC of the battery module 112, the smaller the predetermined value. For example, the predetermined value is decided such that when the voltage or SOC of the battery module 112 is larger than a first value, the predetermined value is smaller than a second value.

The above-described predetermined value may be smaller than the setting value of the overcurrent protection of the protection unit 230. In this manner, the abnormality detection unit 746 can detect the above-described abnormality before the protection unit 230 operates. As a result, for example, fusing of the fuse arranged in the protection unit 230 is prevented.

In another embodiment, the abnormality detection unit 746 detects the above-described abnormality when at least one of the magnitude or the direction of the current flowing between the battery module 112 and the low potential bus 142 meets a predetermined condition. Examples of the predetermined condition include a condition that the magnitude of the current flowing out to the low potential bus 142 from the battery module 112 is larger than a predetermined value, a condition that the direction of the current flowing between the battery module 112 and the low potential bus 142 is different from a predetermined first direction, and the like. The condition that the direction of the current flowing between the battery module 112 and the low potential bus 142 is different from the predetermined first direction may be a condition that the direction of the current flowing between the battery module 112 and the high potential bus 144 is different from a predetermined second direction.

Examples of the predetermined value include (i) the magnitude of the current when the equalization operation determined by the instruction management unit 742 is normally performed, (ii) the magnitude of the current decided based on the voltage or SOC of the battery module 112, and the like. For example, the predetermined value is decided such that the smaller the voltage or SOC of the battery module 112 is than the voltage or SOC of another battery module 114 and/or battery module 116, the larger the above-described current. For example, the predetermined value is decided such that the smaller a difference between the voltage or SOC of the battery module 112 and the voltage or SOC of another battery module 114 and/or battery module 116, the smaller the predetermined value.

The above-described predetermined value may be smaller than the setting value of the overcurrent protection of the protection unit 230. In this manner, the abnormality detection unit 746 can detect the above-described abnormality before the protection unit 230 operates. As a result, for example, fusing of the fuse arranged in the protection unit 230 is prevented.

Examples of the predetermined first direction include (i) a direction of current when the equalization operation determined by the instruction management unit 742 is normally performed, (ii) a direction of current decided based on the voltage or SOC of the battery module 112, and the like. In this manner, for example, even when current having a magnitude smaller than the setting value of the overcurrent protection in the protection unit 230 of the battery module 112 flows in a direction different from a normal time, the assembled battery 210 of the battery module 112 can be quickly protected.

In still another embodiment, the abnormality detection unit 746 detects the above-described abnormality when the status of the equalization operation in the battery module 112, the battery module 114, or the battery module 116 is different from a predetermined status. For example, the abnormality detection unit 746 detects the above-described abnormality when the operation of the DC-DC converter 330 of the battery module 112, the battery module 114, or the battery module 116 is different from a predetermined operation. Examples of the predetermined operation include (i) an operation instructed by the instruction management unit 742, (ii) an operation of generating current of a specific magnitude in a specific direction, and the like.

In an embodiment, the abnormality detection unit 746 determines whether the status of the above-described equalization operation or the operation of the DC-DC converter 330 is different from the predetermined operation, based on the content of the instruction regarding the equalization operation for each battery module managed by the instruction management unit 742 and the status of the equalization operation of each battery module managed by the operation management unit 744. Examples of the equalization operation or the operation of the DC-DC converter 330 include the operation of the discharging control unit 642, the operation of the charging control unit 644, and the like.

For example, when the instruction management unit 742 decides to supply electric power from the battery module 114 to the battery module 112 via the power transmission bus 140, the abnormality detection unit 746 compares the content of the instruction indicated by the signal 32 transmitted from the instruction management unit 742 to the battery module 114 with the operation status of the discharging control unit 642 and/or the charging control unit 644 indicated by the signal 62 and/or the signal 64 received from the battery module 114 by the operation management unit 744. When both contradict each other, the abnormality detection unit 746 detects an abnormality.

In another embodiment, the abnormality detection unit 746 determines whether the status of the above-described equalization operation or the operation of the DC-DC converter 330 is different from the predetermined operation, based on the magnitude of the voltage of each battery module managed by the voltage management unit 722, the magnitude and direction of the current flowing in each battery module managed by the current management unit 724, the magnitude of the SOC of each battery module managed by the SOC management unit 726, and a combination thereof. The magnitude and direction of the current flowing in each battery module may be measured by, for example, an ammeter (not shown) which measures the current of the terminal 242 or the terminal 244 of each battery module.

For example, the abnormality detection unit 746 compares (i) the magnitude of the current of each battery module, the direction of the current, and/or the transition of the voltage or SOC when the DC-DC converter 330 operates as instructed from the system control unit 130 with (ii) the magnitude of the current of each battery module, the direction of the current, and/or the transition of the voltage or SOC which are observed actually. When both contradict each other, the abnormality detection unit 746 detects an abnormality.

In this embodiment, the protection signal output unit 748 outputs the signal 28 for controlling the operation of the switching element 254 of the battery module 112. The signal 28 may be a signal for controlling an opening/closing operation of the switching element 254. The protection signal output unit 748 outputs the above-described signal 28 when the abnormality detection unit 746 detects the abnormality. For example, the protection signal output unit 748 may output the above-described signal 28 when receiving, from the abnormality detection unit 746, a signal indicating that the abnormality is detected.

The protection signal output unit 748 may control the opening/closing operation of the switching element 254 such that (i) the switching element 254 opens the circuit 260 when the abnormality detection unit 746 does not detect the abnormality, and (ii) the switching element 254 closes the circuit 260 when the abnormality detection unit 746 detects the abnormality. For example, when the abnormality detection unit 746 detects the abnormality, the protection signal output unit 748 transmits the signal 28 for closing the circuit 260 to the switching element 254. In an embodiment, the switching element 254 is configured to open the circuit 260 when not receiving the signal 28. In another embodiment, when the abnormality detection unit 746 does not detect the abnormality, the protection signal output unit 748 may transmit the signal 28 for opening the circuit 260 to the switching element 254.

The module balance management unit 740 may be an example of a control device. The abnormality detection unit 746 may be an example of a detection unit. The protection signal output unit 748 may be an example of an opening/closing control unit.

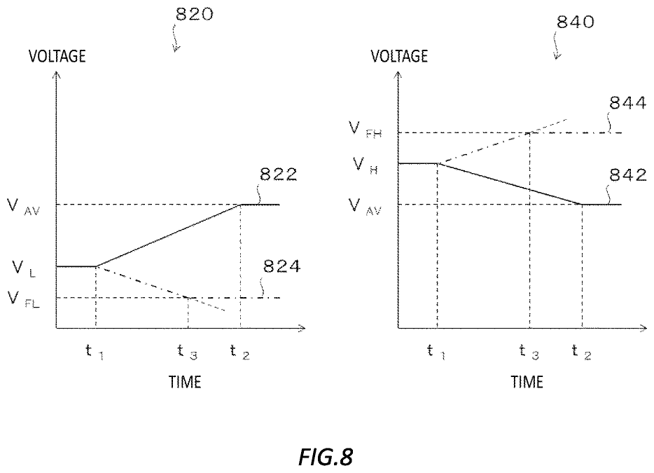

FIG. 8 schematically shows an example of a control operation by the system control unit 130. In this embodiment, for simplicity of description, an example of control regarding the inter-battery module equalization operation will be described by taking, as an example, a case where electric power is supplied from the battery module 114 to the battery module 112 via the power transmission bus 140.

FIG. 8 shows an example of a voltage variation 820 of the battery module 112 and an example of a voltage variation 840 of the battery module 114. A voltage variation 822 indicates the voltage variation of the battery module 112 when the DC-DC converter 330 of the battery module 114 is normally operating. A voltage variation 824 indicates the voltage variation of the battery module 112 when an abnormality has occurred in the DC-DC converter 330 of the battery module 114. Similarly, a voltage variation 842 indicates the voltage variation of the battery module 114 when the DC-DC converter 330 of the battery module 114 is normally operating. A voltage variation 844 indicates the voltage variation of the battery module 114 when an abnormality has occurred in the DC-DC converter 330 of the battery module 114.

According to this embodiment, at time t₁, the voltage of the battery module 112 is V_{L}, and the voltage of the battery module 114 is V_{H}. In addition, the system control unit 130 transmits, to the battery module 114, the signal 28 for controlling the operation of the DC-DC converter 330 of the battery module 114 so that the voltages of the battery module 112 and the battery module 114 become V_{AV} at time t₂. V_{AV} may be an average value of V_{L} and V_{H}.

When the DC-DC converter 330 of the battery module 114 has operated normally, the voltage of the battery module 112 transitions as in the voltage variation 822, and the voltage of the battery module 114 transitions as in the voltage variation 842. On the other hand, when the DC-DC converter 330 of the battery module 114 is not operating normally, there is a possibility that the voltages of the battery module 112 and the battery module 114 do not transition as intended by the system control unit 130.

For example, when the DC-DC converter 330 has failed, there is a possibility that the DC-DC converter 330 does not perform the operation instructed by the instruction management unit 742 or performs an operation different from the operation. As a result, there is a possibility that the potential difference between the low potential bus 142 and the high potential bus 144 becomes larger or smaller than the target value set by the instruction management unit 742.

When a difference between the potential difference between the low potential bus 142 and the high potential bus 144 and the above-described target value increases, the current or electric power flowing into the battery module 112 from the power transmission bus 140 becomes larger than a scheduled value, or the current or electric power flowing out to the power transmission bus 140 from the battery module 112 becomes larger than a scheduled value. For example, when the magnitude of the above-described current is smaller than the setting value of the overcurrent protection circuit arranged in the protection unit 230 of the battery module, there is a possibility that overcharge or overdischarge of the battery module is caused even when the protection unit 230 of the battery module is provided.

According to this embodiment, as indicated by the voltage variation 842 and the voltage variation 844, when an abnormality occurs in the DC-DC converter 330, the voltage of the battery module 112, which is supposed to increase, decreases. In addition, the voltage of the battery module 114, which is supposed to decrease, increases.

However, according to this embodiment, at time t3, the abnormality detection unit 746 detects an abnormality in the inter-battery module equalization operation. In addition, the protection signal output unit 748 outputs the signal 28 for controlling the operation of the switching element 254 of the battery module 112. In this manner, the switching element 254 is closed, and the circuit 260 is short-circuited.

When the circuit 260 is short-circuited, a large current flows in the abnormal operation protection element 252. As a result, the resistance of the abnormal operation protection element 252 increases, or the current flowing in the abnormal operation protection element 252 is shut down, so that the current flowing into the assembled battery 210 of the battery module 112 from the power transmission bus 140 is limited. In this manner, the decrease in the voltage of the battery module 112 stops, or the decrease rate of the voltage decreases. According to this embodiment, at time t3 and later, the voltage of the battery module 112 becomes V_{FL}, and overdischarge of the battery module 112 is prevented.

In addition, when the switching element 254 is closed, the terminal 242 and the terminal 244 are electrically connected via the switching element 254. In this manner, the potential difference between the low potential bus 142 and the high potential bus 144 becomes 0 or substantially 0. As a result, the increase in the voltage of the battery module 114 stops or the increase rate of the voltage decreases. According to this embodiment, at time t3 and later, the voltage of the battery module 114 becomes V_{FH}, and overcharge of the battery module 114 is prevented.

As described above, according to this embodiment, when the abnormality regarding the inter-battery module equalization operation is detected, the inter-battery module equalization operation is stopped or the speed of the equalization decreases. In this manner, even when the DC-DC converter 330 has failed, a safer battery pack 100 is constructed.

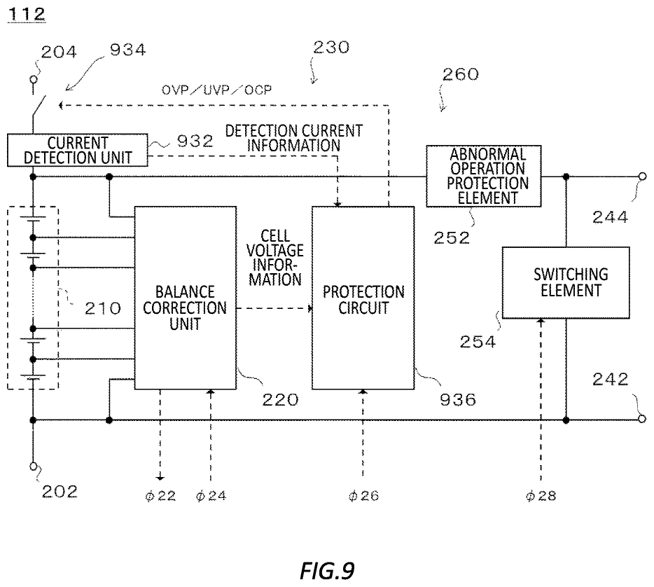

FIG. 9 schematically shows another example of the internal configuration of the battery module 112. FIG. 9 shows an example of the battery module 112 when the protection unit 230 has an overvoltage/overcurrent protection function. In this embodiment, the protection unit 230 includes a current detection unit 932, a switching element 934, and a protection circuit 936.

In this embodiment, the current detection unit 932 is arranged between the terminal 204 and the positive electrode end of the assembled battery 210. The current detection unit 932 detects the magnitude of the current flowing between the terminal 204 and the positive electrode end of the assembled battery 210. The current detection unit 932 may detect that current larger than a predetermined value flows between the terminal 204 and the positive electrode end of the assembled battery 210.

The current detection unit 932 may be arranged between the terminal 204 and a connection point of the positive electrode end of the assembled battery 210 and the abnormal operation protection element 252. The current detection unit 932 may detect the magnitude of the current flowing between the terminal 204 and the connection point of the positive electrode end of the assembled battery 210 and the abnormal operation protection element 252. The current detection unit 932 may detect that current larger than a predetermined value flows between the terminal 204 and the connection point of the positive electrode end of the assembled battery 210 and the abnormal operation protection element 252.

The current detection unit 932 outputs, to the protection circuit 936, information indicating the detected magnitude of the current. The current detection unit 932 may output, to the protection circuit 936, information indicating that the current larger than the predetermined value has flowed.

The arrangement of the current detection unit 932 is not limited to this embodiment. In another embodiment, the current detection unit 932 is arranged between the terminal 202 and the negative electrode end of the assembled battery 210.

As the current detection unit 932, a known current detection sensor can be used. A specific configuration of the current detection sensor is not particularly limited.

In this embodiment, the switching element 934 is arranged between the terminal 204 and the positive electrode end of the assembled battery 210. The current detection unit 932 may be arranged between the terminal 204 and a connection point of the positive electrode end of the assembled battery 210 and the abnormal operation protection element 252. The switching element 934 is turned on or off based on a control signal from the protection circuit 936. For example, when the protection circuit 936 does not output the control signal, the switching element 934 stays turned on. When the switching element 934 receives the control signal from the protection circuit 936, the switching element 934 is turned off.

The arrangement of the switching element 934 is not limited to this embodiment. In another embodiment, the switching element 934 is arranged between the terminal 202 and the negative electrode end of the assembled battery 210.

The type of the switching element 934 is not particularly limited, but examples of the switching element 934 include a mechanical switch, a semiconductor switch, and the like. Examples of the semiconductor switch include a transistor, a thyristor, a triac, and the like. Examples of the transistor include a bipolar transistor (BJT), a field effect transistor (FET), and the like.

In this embodiment, the protection circuit 936 has at least one function of low-voltage protection (which may be referred to as UVP), overvoltage protection (which may be referred to as OVP), or overcurrent protection (which may be referred to as OCP). The protection circuit 936 realizes the above-described function, for example, by controlling the operation of the switching element 934.

For example, the protection circuit 936 acquires, from the module control unit 490 of the balance correction unit 220, information (which may be referred to as cell voltage information) indicating the voltage of each of the plurality of power storage cells constituting the assembled battery 210. The cell voltage information may include information indicating the inter-terminal voltage of the assembled battery 210.

The protection circuit 936 determines whether the voltage of each power storage cell indicated by the above-described voltage information falls within a predetermined numerical range. When the voltage of at least one of the plurality of power storage cells is smaller than a lower limit value of the above-described numerical range, the protection circuit 936 determines that the assembled battery 210 is in a low-voltage state, and outputs, to the switching element 934, a signal for turning off the switching element 934. On the other hand, when the voltage of at least one of the plurality of power storage cells is larger than an upper limit value of the above-described numerical range, the protection circuit 936 determines that the assembled battery 210 is in an overvoltage state, and outputs, to the switching element 934, the signal for turning off the switching element 934.

For example, the protection circuit 936 acquires, from the current detection unit 932, information (which may be referred to as detection current information) indicating the magnitude of the current detected by the current detection unit 932. As described above, the detection current information may be information indicating that the current larger than the predetermined value has been detected.

The protection circuit 936 determines whether the magnitude of the current indicated by the detection current information is larger than a predetermined value. When the detection current information includes the information indicating that the current larger than the predetermined value has been detected, the protection circuit 936 may determine that the magnitude of the current indicated by the detection current information is larger than the predetermined value. When the magnitude of the current indicated by the detection current information is larger than the predetermined value, the protection circuit 936 determines that the assembled battery 210 is in an overcurrent state, and outputs, to the switching element 934, the signal for turning off the switching element 934.

In an embodiment, a setting value (which may be referred to as a setting value regarding the overcurrent of the assembled battery 210) for determining whether the assembled battery 210 is in the overcurrent state is set to be larger than the setting value regarding the magnitude of the current of the abnormal operation protection element 252. When the switching element 934 is turned off, transmission/reception of electric power between the battery module 112 and external equipment is stopped. On the other hand, even when the abnormal operation protection element 252 operates to stop transmission/reception of electric power between the assembled battery 210 and the power transmission bus 140, the transmission/reception of electric power between the battery module 112 and the external equipment can be continued. Therefore, when the setting value regarding the magnitude of the current of the abnormal operation protection element 252 is smaller than the setting value regarding the overcurrent of the assembled battery 210, the deterioration of the power storage cell due to a malfunction in the inter-battery module equalization operation can be suppressed without sacrificing the convenience of a user. In another embodiment, the setting value for determining whether the assembled battery 210 is in the overcurrent state and the setting value regarding the magnitude of the current of the abnormal operation protection element 252 may be the same.

The protection circuit 936 may be constituted by an analog circuit, may be constituted by a digital circuit, or may be constituted by a combination of an analog circuit and a digital circuit. The protection circuit 936 may be implemented by hardware, may be implemented by software, or may be implemented by a combination of hardware and software.

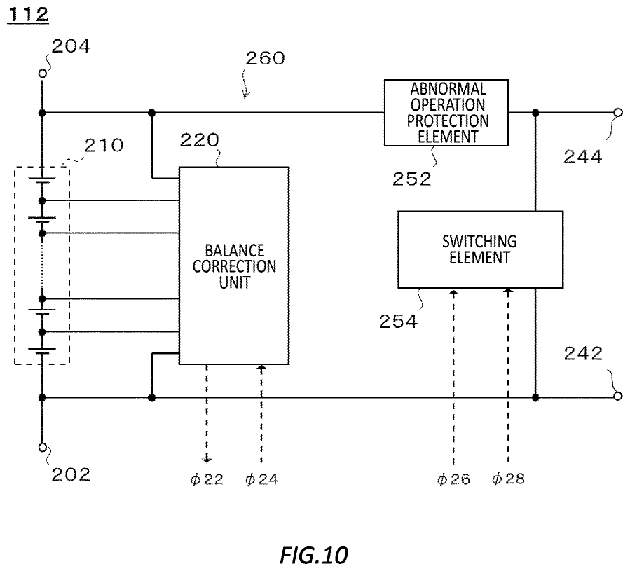

FIG. 10 schematically shows another example of the internal configuration of the battery module 112. FIG. 10 shows an example of the battery module 112 when the abnormal operation protection element 252 and the switching element 254 also function as the protection unit 230. The battery module 112 described in relation to FIG. 10 may have a similar configuration to the battery module 112 described in relation to FIG. 2 except that the protection unit 230 is not provided and that the switching element 254 operates based on the signal 26 and the signal 28.

According to this embodiment, when the abnormality regarding the inter-battery module equalization operation is detected, the switching element 254 short-circuits the circuit 260 based on the signal 28. On the other hand, when overvoltage or overcurrent of the assembled battery 210 is detected, the switching element 254 short-circuits the circuit 260 based on the signal 26.

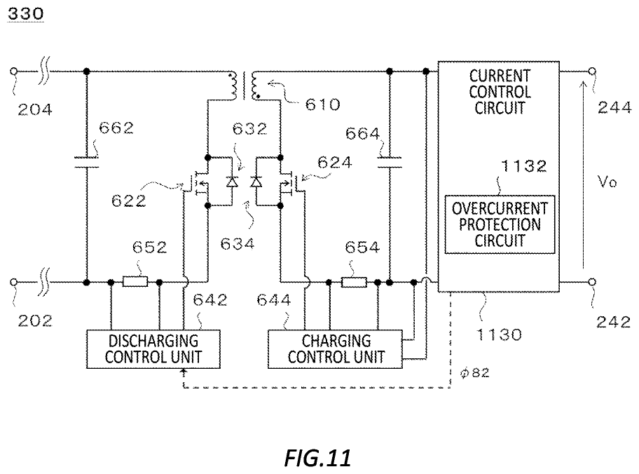

FIG. 11 schematically shows another example of the internal configuration of the DC-DC converter 330. In addition, an example of the DC-DC converter 330 will be described with reference to FIG. 11 by taking, as an example, a case where the charging control unit 644 is driven by using the electric power supplied from the power transmission bus 140. The DC-DC converter 330 described in relation to FIG. 11 may have a similar configuration to the DC-DC converter 330 described in relation to FIG. 6 except that a current control circuit 1130 is provided.

In this embodiment, the current control circuit 1130 controls the magnitude of the discharging current (which may be referred to as an output current of the battery module) of the assembled battery 210. In this manner, the magnitude of the current output from the assembled battery 210 via the power transmission bus 140 is controlled.

In this embodiment, the current control circuit 1130 includes an overcurrent protection circuit 1132. The overcurrent protection circuit 1132 controls the magnitude of the output current such that the magnitude of the output current does not exceed a predetermined value. For example, when the potential difference between the terminal 242 and the terminal 244 decreases, the current control circuit 1130 controls the discharging control unit 642 such that the magnitude of the output current decreases. The current control circuit 1130 may control the discharging control unit 642 by outputting a signal 82 for controlling the discharging control unit 642. Details of the overcurrent protection circuit 1132 will be described below.

The current control circuit 1130 may be an example of a current control unit. The DC-DC converter 330 operated by the electric power supplied from the power transmission bus 140 may be an example of a power transmission/reception unit operated by the electric power supplied from the first power line and the second power line.

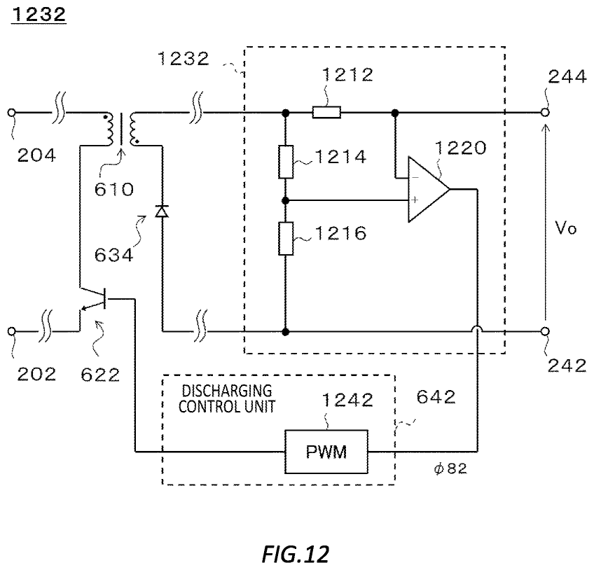

FIG. 12 schematically shows an example of the circuit configuration of the overcurrent protection circuit 1232. The overcurrent protection circuit 1232 may be an example of the above-described overcurrent protection circuit 1132. The overcurrent protection circuit 1232 may be an example of an overcurrent protection circuit referred to as a foldback type, a foldback control type, or the like.

In this embodiment, the overcurrent protection circuit 1232 includes, for example, a resistor 1212, a resistor 1214, a resistor 1216, and a comparator 1220. In FIG. 12, for simplicity of description, a positive power supply terminal and a negative power supply terminal of the comparator 1220 are not shown. For example, the positive power supply terminal of the comparator 1220 is electrically connected to the terminal 244. For example, the negative power supply terminal of the comparator 1220 is electrically connected to the terminal 242.

One end of the resistor 1212 is electrically connected to the terminal 244 and the inverting input terminal of the comparator 1220. The other end of the resistor 1212 is electrically connected to one end of the transformer 610 and one end of the resistor 1214. The other end of the resistor 1214 is electrically connected to the non-inverting input terminal of the comparator 1220 and one end of the resistor 1216. The other end of the resistor 1216 is electrically connected to one end of the diode 634 and the terminal 242. The other end of the diode 634 is electrically connected to the other end of the transformer 610. The comparator 1220 outputs the signal 82. The signal 82 output from comparator 1220 is transmitted to the discharging control unit 642. The signal 82 may be a signal for controlling the operation of a pulse width modulator 1242 arranged in the discharging control unit 642.

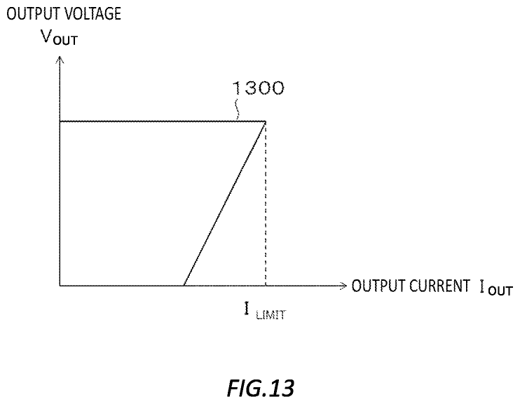

FIG. 13 schematically shows an example of the voltage-current characteristic of the overcurrent protection circuit 1232. As indicated in a characteristic 1300, the overcurrent protection circuit 1232 has a characteristic that an output current I_{OUT} and an output voltage V_{OUT} decrease when the output current I_{OUT} reaches an overcurrent setting value I_{LIMIT}. Note that according to this embodiment, even when the output voltage V_{OUT} of the overcurrent protection circuit 1232 becomes 0 [V], the magnitude of the output current I_{OUT} of the overcurrent protection circuit 1232 has a value larger than 0 [A] and smaller than the rated current. In another embodiment, when the output voltage V_{OUT} of the overcurrent protection circuit 1232 becomes 0 [V], the magnitude of the output current I_{OUT} of the overcurrent protection circuit 1232 may become 0 [A].

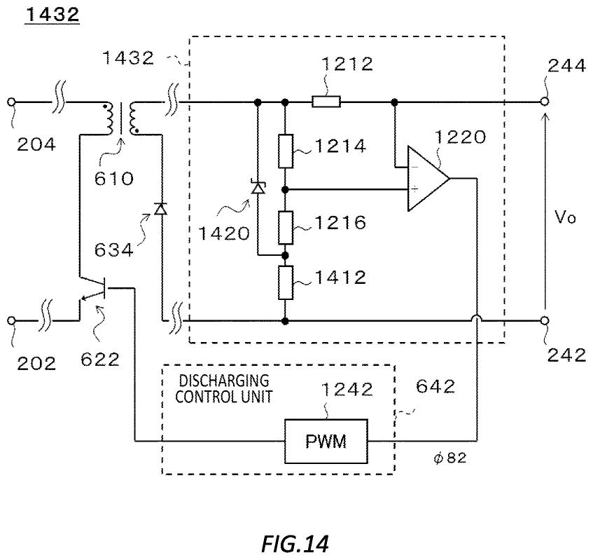

FIG. 14 schematically shows an example of the circuit configuration of the overcurrent protection circuit 1432. The overcurrent protection circuit 1432 may be an example of the above-described overcurrent protection circuit 1132. The overcurrent protection circuit 1432 may be an example of an overcurrent protection circuit referred to as a foldback type, a foldback control type, or the like.

In this embodiment, the overcurrent protection circuit 1432 includes, for example, the resistor 1212, the resistor 1214, the resistor 1216, the resistor 1412, a Zener diode 1420, and the comparator 1220. In FIG. 14, for simplicity of description, the positive power supply terminal and the negative power supply terminal of the comparator 1220 are not shown. For example, the positive power supply terminal of the comparator 1220 is electrically connected to the terminal 244. For example, the negative power supply terminal of the comparator 1220 is electrically connected to the terminal 242.

One end of the resistor 1212 is electrically connected to the terminal 244 and the inverting input terminal of the comparator 1220. The other end of the resistor 1212 is electrically connected to one end of the transformer 610 and one end of the resistor 1214. The other end of the resistor 1214 is electrically connected to the non-inverting input terminal of the comparator 1220 and one end of the resistor 1216. The other end of the resistor 1216 is electrically connected to one end of the resistor 1412 and one end of the Zener diode 1420. The other end of the Zener diode 1420 is electrically connected to one end of the transformer 610, the other end of the resistor 1212, and one end of the resistor 1214. The other end of the resistor 1412 is electrically connected to one end of the diode 634 and the terminal 242. The other end of the diode 634 is electrically connected to the other end of the transformer 610. The comparator 1220 outputs the signal 82. The signal 82 output from comparator 1220 is transmitted to the discharging control unit 642. The signal 82 may be a signal for controlling the operation of a pulse width modulator 1242 arranged in the discharging control unit 642.

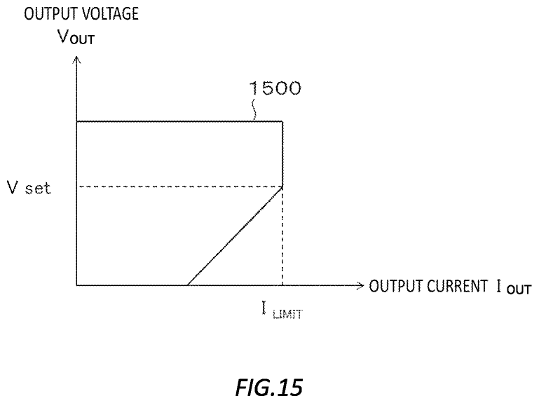

FIG. 15 schematically shows an example of the voltage-current characteristic of the overcurrent protection circuit 1432. As indicated in a characteristic 1500, the overcurrent protection circuit 1232 has a characteristic that when the output current I_{OUT} reaches the overcurrent setting value I_{LIMIT}, the output voltage V_{OUT} linearly droops while the output current I_{OUT} remains in a constant current state until the output voltage V_{OUT} becomes Vₛₑₜ. In addition, the overcurrent protection circuit 1232 has a characteristic that both the output current I_{OUT} and the output voltage V_{OUT} decrease when the output voltage V_{OUT} reaches Vₛₑₜ.

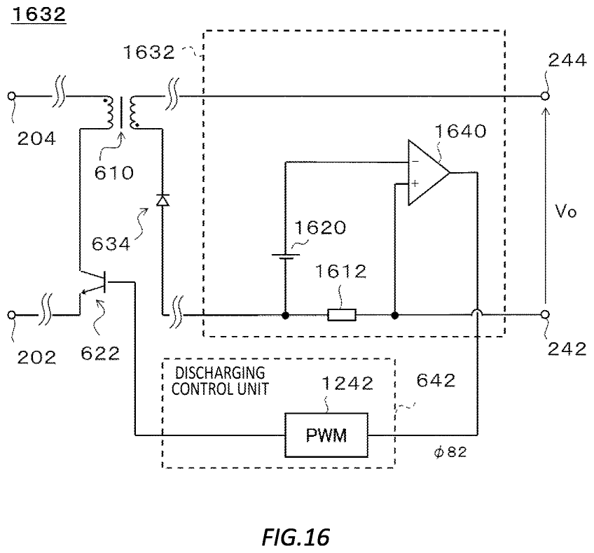

FIG. 16 schematically shows an example of the circuit configuration of the overcurrent protection circuit 1632. The overcurrent protection circuit 1632 may be an example of the above-described overcurrent protection circuit 1132. The overcurrent protection circuit 1632 may be an example of an overcurrent protection circuit referred to as a drooping type, a fixed current limiting type, or the like.

In this embodiment, the overcurrent protection circuit 1632 includes, for example, a resistor 1612, a power supply 1620, and a comparator 1640. In FIG. 16, for simplicity of description, the positive power supply terminal and the negative power supply terminal of the comparator 1640 are not shown. For example, the positive power supply terminal of the comparator 1640 is electrically connected to the terminal 244. For example, the negative power supply terminal of the comparator 1640 is electrically connected to the terminal 242.

One end of the transformer 610 is electrically connected to the terminal 244. One end of the resistor 1612 is electrically connected to the terminal 242 and the non-inverting input terminal of the comparator 1640. The other end of the resistor 1612 is electrically connected to the negative electrode end of the power supply 1620 and one end of the diode 634. The positive electrode end of the power supply 1620 is electrically connected to the inverting input terminal of the comparator 1640. The other end of the diode 634 is electrically connected to the other end of the transformer 610. The comparator 1640 outputs the signal 82. The signal 82 output from comparator 1640 is transmitted to the discharging control unit 642. The signal 82 may be a signal for controlling the operation of a pulse width modulator 1242 arranged in the discharging control unit 642.

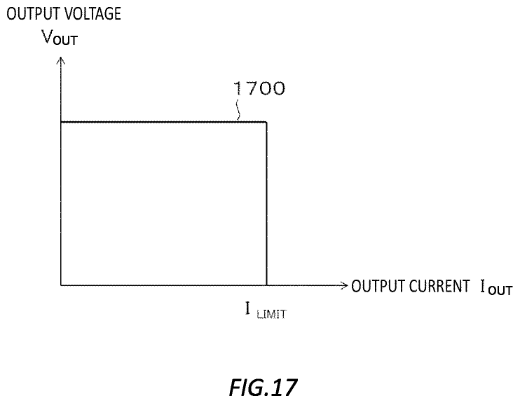

FIG. 17 schematically shows an example of the voltage-current characteristic of the overcurrent protection circuit 1632. As illustrated in a characteristic 1700, the overcurrent protection circuit 1632 has a characteristic that when the output current I_{OUT} reaches the overcurrent setting value I_{LIMIT}, the output voltage V_{OUT} linearly droops while the output current I_{OUT} remains in the constant current state.

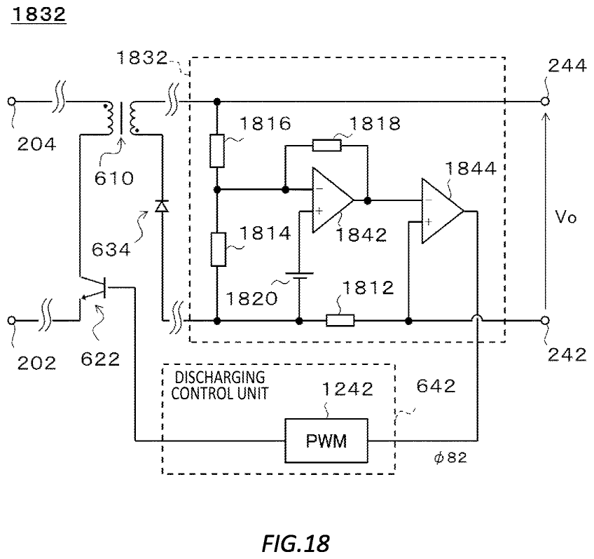

FIG. 18 schematically shows an example of the circuit configuration of the overcurrent protection circuit 1832. The overcurrent protection circuit 1832 may be an example of the above-described overcurrent protection circuit 1132. The overcurrent protection circuit 1832 may be an example of an overcurrent protection circuit referred to as a constant power control voltage drooping type or the like.

In this embodiment, the overcurrent protection circuit 1832 includes, for example, a resistor 1812, a resistor 1814, a resistor 1816, a resistor 1818, a power supply 1820, a comparator 1842, and a comparator 1844. In FIG. 18, for simplicity of description, the positive power supply terminals and the negative power supply terminals of the comparator 1842 and the comparator 1844 are not shown. For example, the above-described positive power supply terminal is electrically connected to the terminal 244. For example, the above-described negative power supply terminal is electrically connected to the terminal 242.

One end of the resistor 1812 is electrically connected to the terminal 242 and the non-inverting input terminal of the comparator 1844. The other end of the resistor 1812 is electrically connected to the negative electrode end of the power supply 1820, one end of the resistor 1814, and one end of the diode 634. The other end of the resistor 1814 is electrically connected to the inverting input terminal of the comparator 1842, one end of the resistor 1816, and one end of the resistor 1818. The other end of the resistor 1816 is electrically connected to one end of the transformer 610 and the terminal 244. The other end of the resistor 1818 is electrically connected to the output terminal of the comparator 1842 and the inverting input terminal of the comparator 1844. The positive electrode end of the power supply 1820 is electrically connected to the non-inverting input terminal of the comparator 1842. The other end of the diode 634 is electrically connected to the other end of the transformer 610. The comparator 1844 outputs the signal 82. The signal 82 output from comparator 1844 is transmitted to the discharging control unit 642. The signal 82 may be a signal for controlling the operation of a pulse width modulator 1242 arranged in the discharging control unit 642.

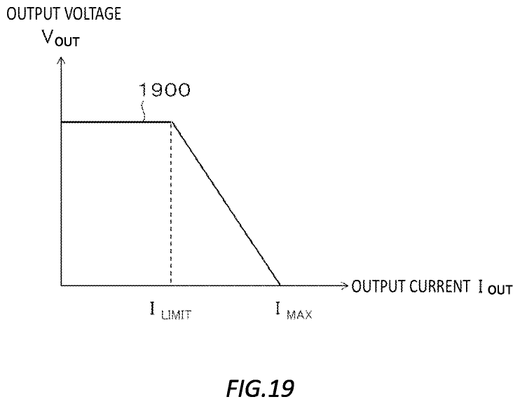

FIG. 19 schematically shows an example of the voltage-current characteristic of the overcurrent protection circuit 1832. As indicated in a characteristic 1900, the overcurrent protection circuit 1832 has a characteristic that when the output current I_{OUT} reaches the overcurrent setting value I_{LIMIT}, the output current I_{OUT} increases while the output voltage V_{OUT} decreases. As indicated in the characteristic 1900, the output current I_{OUT} of the overcurrent protection circuit 1832 is controlled so as not to exceed a setting value I_{MAX}.

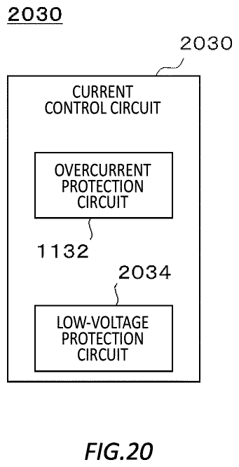

FIG. 20 schematically shows an example of the internal configuration of the current control circuit 2030. The current control circuit 2030 is different from the current control circuit 1130 in that the overcurrent protection circuit 1132 and a low-voltage protection circuit 2034 are provided. Regarding the features other than the above-described difference, the current control circuit 2030 may have a similar configuration to the current control circuit 1130.

In this embodiment, when the output voltage of the DC-DC converter 330 is smaller than a predetermined value, the low-voltage protection circuit 2034 controls the output of the assembled battery 210 such that the output from the assembled battery 210 is stopped. For example, when the potential difference between the terminal 242 and the terminal 244 becomes smaller than a predetermined value, the low-voltage protection circuit 2034 controls the discharging control unit 642 such that the magnitude of the output current decreases. According to this embodiment, when the voltage output from the assembled battery 210 to the power transmission bus 140 via the DC-DC converter 330 is smaller than a predetermined value, the output from the assembled battery 210 is stopped. In this manner, the safety of the battery pack 100 is further improved.

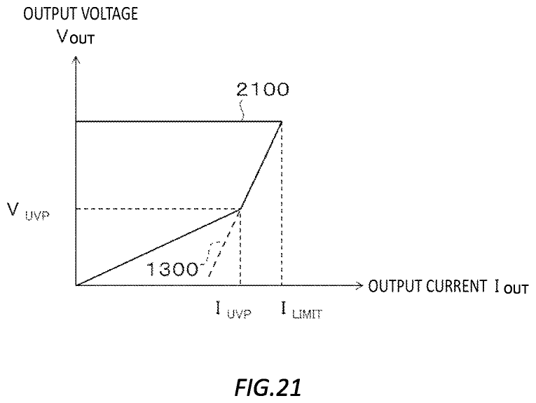

FIG. 21 schematically shows an example of the voltage-current characteristic of the current control circuit 2030. The operation of the low-voltage protection circuit 2034 will be described with reference to FIG. 21 by taking, as an example, a case where the overcurrent protection circuit 1132 of the current control circuit 2030 is the overcurrent protection circuit 1232. As shown in a characteristic 2100, the current control circuit 2030 has a characteristic that when the output current I_{OUT} reaches the overcurrent setting value I_{LIMIT}, the output current I_{OUT} and the output voltage V_{OUT} decrease until the output voltage V_{OUT} becomes V_{UVP}, similarly to the characteristic 1300. The current control circuit 2030 is different from the overcurrent protection circuit 1232 in that the current control circuit 2030 has a characteristic that when the output voltage V_{OUT} reaches V_{UVP}, the output current I_{OUT} and the output voltage V_{OUT} decrease so that the magnitude of the output current I_{OUT} becomes 0 [A] when the output voltage V_{OUT} becomes 0 [V].

In FIGS. 20 and 21, an example of the function of the low-voltage protection circuit 2034 has been described by taking, as an example, a case where the current control circuit 2030 includes the overcurrent protection circuit 1232 and the low-voltage protection circuit 2034. However, the current control circuit 2030 is not limited to this embodiment. In another embodiment, the current control circuit 2030 may include any type of overcurrent protection circuit and the low-voltage protection circuit 2034. For example, the current control circuit 2030 includes the overcurrent protection circuit 1432, the overcurrent protection circuit 1632 or the overcurrent protection circuit 1832, and the low-voltage protection circuit 2034.

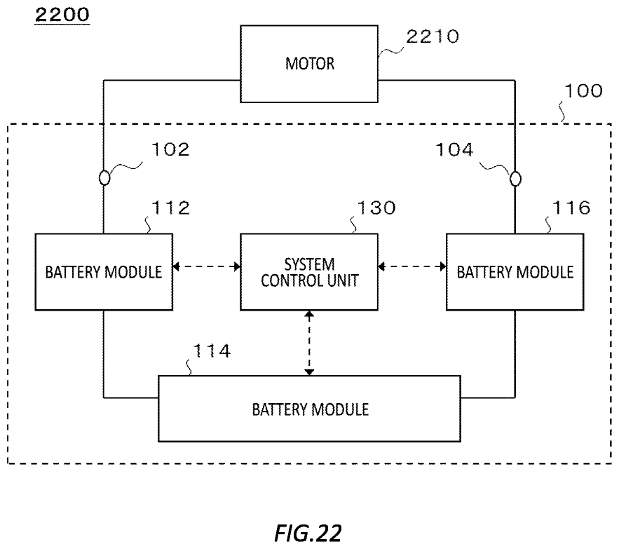

FIG. 22 schematically shows an example of a system configuration of an electric vehicle 2200. In this embodiment, the electric vehicle 2200 includes the battery pack 100 and a motor 2210. The electric vehicle 2200 moves by using the electric power of the battery pack 100. The motor 2210 generates power by using the electric power of the battery pack 100.

According to this embodiment, for example, the battery module 112, the battery module 114, and the battery module 116 are arranged at different positions of the electric vehicle 2200. When the plurality of battery modules are arranged at different positions of the electric vehicle 2200, the environment surrounding each battery module varies depending on the position where each battery module is arranged. Examples of the above-described environment can include temperature, humidity, temperature change, humidity change, and the like. Therefore, the variation in deterioration state between a plurality of battery modules may increase over time. As a result, a balance in voltage or SOC between a plurality of battery modules may deviate from an originally set value. For example, when the electric vehicle 2200 is a large vehicle such as a bus or a truck, the above-described tendency becomes particularly remarkable since a distance between the plurality of battery modules increases.

However, according to the battery pack 100 in this embodiment, even if the voltages or SOCs of a plurality of battery modules are unbalanced, electric power can be transmitted/received to/from the plurality of battery modules. In this manner, the performance of the battery pack 100 is recovered. In addition, the battery pack 100 can be efficiently used.

The electric vehicle 2200 may be an example of electric equipment or a moving body. The motor 2210 may be an example of a load.

### One Example of Another Embodiment

In this embodiment, the details of the electric equipment using electric power have been described by using the electric vehicle 2200 as an example. However, the electric equipment is not limited to the electric vehicle 2200. The type of the electric equipment is not particularly limited, but in another embodiment, the electric equipment may be a stationary power supply facility or an electric storage facility, or may be a home appliance.

In this embodiment, the details of the moving body which moves by using electric power have been described by using the electric vehicle 2200 as an example. However, the moving body is not limited to the electric vehicle 2200. The type of the moving body is not particularly limited, but examples of the moving body include a vehicle, a marine vessel, a flight vehicle, and the like. Examples of the vehicle include an automobile, a motorcycle, a standing vehicle having an electric unit, a train, and the like. Examples of the automobile include an electric vehicle, a fuel cell vehicle, a hybrid vehicle, a small sized commuter, an electric cart, and the like. Examples of the motorcycle include an electric motorcycle, an electric trike, an electric bicycle, and the like. Examples of the marine vessel include a ship, a hovercraft, a water bike, a submarine, a submersible craft, an underwater scooter, and the like. Examples of the flight vehicle include an airplane, an air ship or a balloon, a hot-air balloon, a helicopter, a drone, and the like.

While the present invention has been described by way of the embodiments, the technical scope of the present invention is not limited to the above described embodiments. It is apparent to persons skilled in the art that various alterations or improvements can be made to the above described embodiments. For example, unless a technical contradiction occurs, the matters described in the particular embodiment can be applied to another embodiment. In addition, each constitutional element may have features similar to those of other constitutional elements which have the same name and have the different numerals. It is also apparent from the description of the claims that embodiments added with such alterations or improvements can be included in the technical scope of the present invention.

The operations, procedures, steps, and stages of each process performed by an apparatus, system, program, and method illustrated in the claims, embodiments, or diagrams can be performed in any order as long as the order is not indicated by “prior to,” “before,” or the like and as long as the outputted from a previous process is not used in a later process. Even if the operation flow is described by using phrases such as “first” or “next” in the scope of the claims, specification, or drawings, it does not necessarily mean that the process must be performed in this order.

### EXPLANATION OF REFERENCES

22: signal; 24: signal; 26: signal; 28: signal; 32: signal; 52: drive signal; 54: drive signal; 56: signal; 58: signal; 62: signal; 64: signal; 82: signal; 100: battery pack; 102: terminal; 104: terminal; 112: battery module; 114: battery module; 116: battery module; 130: system control unit; 140: power transmission bus; 142: low potential bus; 144: high potential bus; 202: terminal; 204: terminal; 210: assembled battery; 220: balance correction unit; 230: protection unit; 242: terminal; 244: terminal; 252: abnormal operation protection element; 254: switching element; 260: circuit; 330: DC-DC converter; 412: power storage cell; 414: power storage cell; 416: power storage cell; 418: power storage cell; 432: balance correction circuit; 434: balance correction circuit; 436: balance correction circuit; 443: connection point; 445: connection point; 447: connection point; 490: module control unit; 545: connection point; 550: inductor; 552: switching element; 554: switching element; 562: diode; 564: diode; 570: equalization control unit; 580: voltage monitoring unit; 582: voltage detection unit; 584: voltage detection unit; 586: difference detection unit; 610: transformer; 622: switching element; 624: switching element; 632: diode; 634: diode; 642: discharging control unit; 644: charging control unit; 652: current detection unit; 654: current detection unit; 662: capacitor; 664: capacitor; 720: module management unit; 722: voltage management unit; 724: current management unit; 726: SOC management unit; 728: cell balance management unit; 740: module balance management unit; 742: instruction management unit; 744: operation management unit; 746: abnormality detection unit; 748: protection signal output unit; 820: voltage variation; 822: voltage variation; 824: voltage variation; 840: voltage variation; 842: voltage variation; 844: voltage variation; 932: current detection unit; 934: switching element; 936: protection circuit; 1130: current control circuit; 1132: overcurrent protection circuit; 1212: resistor; 1214: resistor; 1216: resistor; 1220: comparator; 1232: overcurrent protection circuit; 1242: pulse width modulator; 1300: characteristic; 1412: resistor; 1420: Zener diode; 1432: overcurrent protection circuit; 1500: characteristic; 1612: resistor; 1620: power supply; 1632: overcurrent protection circuit; 1640: comparator; 1700: characteristic; 1812: resistor; 1814: resistor; 1816: resistor; 1818: resistor; 1820: power supply; 1832: overcurrent protection circuit; 1842: comparator; 1844: comparator; 1900: characteristic; 2030: current control circuit; 2034: low-voltage protection circuit; 2100: characteristic; 2200: electric vehicle; and 2210: motor.

What is claimed is:

1. A power storage system comprising:
a power transmission/reception unit which transmits/receives electric power between a first assembled battery including a plurality of first power storage cells connected in series and a second assembled battery including a plurality of second power storage cells connected in series;
a first power line which is electrically connected to a positive electrode terminal of the first assembled battery and electrically connected to a positive electrode terminal of the second assembled battery via the power transmission/reception unit;
a second power line which is electrically connected to a negative electrode terminal of the first assembled battery and electrically connected to a negative electrode terminal of the second assembled battery via the power transmission/reception unit; and
a limitation unit which is arranged between the positive electrode terminal of the first assembled battery and the first power line or between the negative electrode terminal of the first assembled battery and the second power line, and limits transmission/reception of electric power via the power transmission/reception unit between the first assembled battery and the second assembled battery, wherein
the first assembled battery and the second assembled battery are connected in series,
the power transmission/reception unit transmits/receives electric power via the first power line and the second power line between the first assembled battery and the second assembled battery, and
the limitation unit limits transmission/reception of electric power via the power transmission/reception unit between the first assembled battery and the second assembled battery when an abnormality regarding power transmission or power reception of the power transmission/reception unit is detected.

2. The power storage system according to claim 1, wherein
when the abnormality of the power transmission/reception unit is detected,
the limitation unit (i) reduces current flowing into the first assembled battery from the second assembled battery via the first power line compared to before the abnormality is detected or (ii) shuts down the current.

3. The power storage system according to claim 1, wherein
(i) when a direction of current in at least one of the first power line, the second power line, or the power transmission/reception unit is different from a predetermined direction, (ii) when a magnitude of current flowing into the first assembled battery from the first power line is larger than a predetermined value, (iii) when a magnitude of current flowing out to the second power line from the first assembled battery is larger than a predetermined value, or (iv) when an operation of the power transmission/reception unit is different from a predetermined operation, the abnormality of the power transmission/reception unit is detected.

4. The power storage system according to claim 1, further comprising:
a short circuit which connects the positive electrode terminal of the first assembled battery, the limitation unit, and the negative electrode terminal of the first assembled battery in series; and
an opening/closing unit which opens/closes the short circuit, wherein
the limitation unit limits transmission/reception of electric power via the power transmission/reception unit between the first assembled battery and the second assembled battery when the short circuit is closed, and
the opening/closing unit
opens the short circuit when the abnormality of the power transmission/reception unit is not detected, and
closes the short circuit when the abnormality of the power transmission/reception unit is detected.

5. The power storage system according to claim 4, further comprising:
a detection unit which detects the abnormality of the power transmission/reception unit; and
an opening/closing control unit which controls an opening/closing operation of the opening/closing unit when the detection unit detects the abnormality of the power transmission/reception unit.

6. The power storage system according to claim 1, wherein
the limitation unit includes at least one of a fuse, an electronic fuse, a PTC thermistor, or a switching element.

7. The power storage system according to claim 1, wherein
the power transmission/reception unit includes an insulated bidirectional DC-DC converter.

8. The power storage system according to claim 1, wherein
the first assembled battery includes a first equalization unit which equalizes voltages of the plurality of first power storage cells, or
the second assembled battery includes a second equalization unit which equalizes voltages of the plurality of second power storage cells.

9. The power storage system according to claim 1, further comprising
a current control unit which controls a magnitude of an output current which is current output from the second assembled battery via the power transmission/reception unit, wherein
the current control unit includes
an overcurrent protection circuit which controls the magnitude of the output current such that the magnitude of the output current does not exceed a predetermined value.

10. The power storage system according to claim 9, wherein
the current control unit further includes
a low-voltage protection circuit which stops output from the second assembled battery when an output voltage which is voltage output from the second assembled battery via the power transmission/reception unit is smaller than a predetermined value.

11. The power storage system according to claim 9, wherein
the power transmission/reception unit operates by electric power supplied from the first power line and the second power line.

12. The power storage system according to claim 1, further comprising:
the first assembled battery; and
the second assembled battery.

13. The power storage system according to claim 2, wherein
(i) when a direction of current in at least one of the first power line, the second power line, or the power transmission/reception unit is different from a predetermined direction, (ii) when a magnitude of current flowing into the first assembled battery from the first power line is larger than a predetermined value, (iii) when a magnitude of current flowing out to the second power line from the first assembled battery is larger than a predetermined value, or (iv) when an operation of the power transmission/reception unit is different from a predetermined operation, the abnormality of the power transmission/reception unit is detected.

14. The power storage system according to claim 2, further comprising:
a short circuit which connects the positive electrode terminal of the first assembled battery, the limitation unit, and the negative electrode terminal of the first assembled battery in series; and
an opening/closing unit which opens/closes the short circuit, wherein
the limitation unit limits transmission/reception of electric power via the power transmission/reception unit between the first assembled battery and the second assembled battery when the short circuit is closed, and
the opening/closing unit
opens the short circuit when the abnormality of the power transmission/reception unit is not detected, and
closes the short circuit when the abnormality of the power transmission/reception unit is detected.

15. The power storage system according to claim 3, further comprising:
a short circuit which connects the positive electrode terminal of the first assembled battery, the limitation unit, and the negative electrode terminal of the first assembled battery in series; and
an opening/closing unit which opens/closes the short circuit, wherein
the limitation unit limits transmission/reception of electric power via the power transmission/reception unit between the first assembled battery and the second assembled battery when the short circuit is closed, and
the opening/closing unit
opens the short circuit when the abnormality of the power transmission/reception unit is not detected, and
closes the short circuit when the abnormality of the power transmission/reception unit is detected.

16. The power storage system according to claim 2, wherein
the limitation unit includes at least one of a fuse, an electronic fuse, a PTC thermistor, or a switching element.

17. Electric equipment comprising:
the power storage system according to claim 1; and
a load which uses electric power of the power storage system.

18. The electric equipment according to claim 17, wherein
the electric equipment is a moving body which moves by using the electric power of the power storage system.

19. A control device which controls a power storage system, wherein
the power storage system includes
a power transmission/reception unit which transmits/receives electric power between a first assembled battery including a plurality of first power storage cells connected in series and a second assembled battery including a plurality of second power storage cells connected in series,
a first power line which is electrically connected to a positive electrode terminal of the first assembled battery and electrically connected to a positive electrode terminal of the second assembled battery via the power transmission/reception unit,
a second power line which is electrically connected to a negative electrode terminal of the first assembled battery and electrically connected to a negative electrode terminal of the second assembled battery via the power transmission/reception unit,
a limitation unit which is arranged between the positive electrode terminal of the first assembled battery and the first power line or between the negative electrode terminal of the first assembled battery and the second power line, and limits transmission/reception of electric power via the power transmission/reception unit between the first assembled battery and the second assembled battery,
a short circuit which connects the positive electrode terminal of the first assembled battery, the limitation unit, and the negative electrode terminal of the first assembled battery in series, and
an opening/closing unit which opens/closes the short circuit, wherein
the first assembled battery and the second assembled battery are connected in series,
the power transmission/reception unit transmits/receives electric power via the first power line and the second power line between the first assembled battery and the second assembled battery,
the limitation unit limits transmission/reception of electric power via the power transmission/reception unit between the first assembled battery and the second assembled battery when the short circuit is closed,
the control device includes
a detection unit which detects an abnormality regarding power transmission or power reception of the power transmission/reception unit, and
an opening/closing control unit which controls an opening/closing operation of the opening/closing unit, and
the opening/closing control unit
controls the opening/closing operation of the opening/closing unit such that (i) the opening/closing unit opens the short circuit when the detection unit does not detect the abnormality of the power transmission/reception unit, and (ii) the opening/closing unit closes the short circuit when the detection unit detects the abnormality of the power transmission/reception unit.

20. The control device according to claim 19, wherein
(i) when a direction of current in at least one of the first power line, the second power line, or the power transmission/reception unit is different from a predetermined direction, (ii) when a magnitude of current flowing into the first assembled battery from the first power line is larger than a predetermined value, (iii) when a magnitude of current flowing out to the second power line from the first assembled battery is larger than a predetermined value, or (iv) when an operation of the power transmission/reception unit is different from a predetermined operation,
the detection unit detects the abnormality of the power transmission/reception unit.
